(19) United States
(12) Patent Application Publication
(10) Pub. No.: US 2018/0171086 A1
(43) Pub. Date: Jun. 21, 2018

(54) LARGE AREA MONOLAYER OF PERFLUORO POLYMERS

(71) Applicant: South Dakota Board of Regents, Pierre, SD (US)

(72) Inventor: Haoran Sun, Vermillion, SD (US)

(73) Assignee: South Dakota Board of Regents, Pierre, SD (US)

(21) Appl. No.: 15/843,828

(22) Filed: Dec. 15, 2017

Related U.S. Application Data
(60) Provisional application No. 62/435,380, filed on Dec. 16, 2016.

(51) Int. Cl. C08J 5/18; C08G 12/08

(52) U.S. Cl. CPC C08J 5/18; C08J 2361/22; C08G 12/08

(57) ABSTRACT

Synthesis and growth of large area free-standing ultra-thin two-dimensional (2D) polymeric films including 2D covalent organic frameworks (COF) are achieved by utilizing fluorocarbon-soluble fluorinated aldehyde derivatives and hydrocarbon-soluble amine derivatives at a liquid-liquid interface of respective fluorocarbon and hydrocarbon solvents.

### RELATED APPLICATIONS

This application claims priority under 35 U.S.C. § 119(e) to U.S. Provisional Patent Application No. 62/435,380, filed Dec. 16, 2016, which is incorporated herein by reference.

### GOVERNMENT SUPPORT

This invention was made with government support under Grant No. CHE1355677 awarded by the National Science Foundation. The government has certain rights in the invention.

### BACKGROUND OF THE INVENTION

Production of large area free standing ultra-thin two-dimensional (2D) polymeric and covalent organic framework (COF) films is expected to have significant impacts on many fields including electronics, optics and optoelectronics, sensing, separation sciences, and clean energy applications. Substantial production challenges have yet to be overcome prior to full industrialization of these materials, though many fantastic works have shown promising results towards reaching these goals. One key challenge in making large area 2D polymeric and COF thin films is that the polymer and COF formation reaction still occurs in traditional bulk solutions. As the 2D polymer and 2D COF formation reaction occurs in the bulk solution, the 2D polymer and 2D COFs often precipitate out of solution in a bulk solid form during preparation processes or at least form a mixture of thin film and bulk solid materials. A flow reaction apparatus was recently developed to produce 2D COF film with the thickness of few hundred nanometers. Post-synthesis self-assembly of 2D COF at the air-water interface was recently reported (Khayum, M. A.; Kandambeth, S.; Mitra, S.; Nair, S. B.; Das, A.; Nagane, S. S.; Mukherjee, R.; Banerjee, R. Angew. Chem., Int. Ed. 2016). However, the 2D polymeric and 2D COF films are often aggregated and the area to thickness ratio is fairly small.

The preparation of monolayer films with high aspect ratios remains a challenge. Accordingly, a solution which is simple yet able to provide high aspect ratio polymer films is needed.

### SUMMARY

To produce large area free standing ultra-thin 2D polymeric and COF films with the potential to realize a single layer 2D functional polymeric and COF films, we describe a new synthetic strategy that utilizes immiscible fluorocarbon and hydrocarbon solvents to form a liquid-liquid interfacial reaction center at which a large area ultra-thin 2D COF film can be formed under the condition that each monomer or COF precursor can only be dissolved in one of respective solvents (FIG. 1). To demonstrate this concept, we utilize a fluorocarbon-soluble 2,5-bis(nonafluorobutyl)-1,4-phthalaldehyde (M-1 in Scheme 1) that is insoluble in polar hydrocarbon organic solvents (for example, DMSO, DMF, CH₃CN) and hydrocarbon-soluble 1,3,5-(4-aminophenyl)benzene (N-1) that is insoluble in fluorocarbon solvents to prepare the thin COF film at the interface between a polar hydrocarbon solvent and a fluorocarbon solvent (for example, ethoxy-nonafluorobutane (C₄F₉OC₂H₅), 3M™ Novec™ 7200 Engineered Fluid, abbreviated as HFE-7200 in this paper).

Accordingly, this disclosure provides a fluoropolymer film comprising: a) a repeat unit A, wherein a monomer 1A that forms repeat unit A is soluble in a polar organic solvent and is substantially insoluble in a fluorocarbon solvent; and b) a repeat unit B, wherein a monomer 2B that forms repeat unit B is soluble in the fluorocarbon solvent and is substantially insoluble in the polar organic solvent, and wherein repeat unit B and monomer 2B are substituted with a perfluorocarbon substituent; wherein a combined repeating unit of the fluoropolymer film comprises repeat unit A and repeat unit B covalently bonded together, and the fluoropolymer film has a thickness of about 0.1 nm to about 10,000 nm and an area to thickness aspect ratio of about 10³ to about 10¹⁴.

This disclosure also provides a fluoropolymer monolayer comprising: a) an aromatic repeat unit A, wherein an amino substituted monomer 1A that forms repeat unit A is soluble in a polar organic solvent and is substantially insoluble in a fluorocarbon solvent; and b) an aromatic repeat unit B, wherein a carbaldehyde substituted monomer 2B that forms repeat unit B is soluble in the fluorocarbon solvent and is substantially insoluble in the polar organic solvent, and wherein repeat unit B and monomer 2B are substituted with a perfluorocarbon substituent; wherein a combined repeating unit of the fluoropolymer monolayer comprises repeat unit A and repeat unit B covalently bonded together via an imine linkage, and the fluoropolymer monolayer has a thickness of about 0.1 nm to about 100 nm, and an area to thickness aspect ratio of about 10⁴ to about 10¹⁰.

Additionally, this disclosure provides a method of preparing a fluoropolymer film, comprising: a) dissolving an aromatic monomer 1A in a polar organic solvent to form solution 1; b) dissolving an aromatic monomer 2B in a fluorocarbon solvent to form solution 2, wherein monomer 2B has at least one perfluorocarbon substituent; and c) combining solution 1 and solution 2 to form a bilayer interface wherein solution 1 and solution 2 are substantially immiscible with each other, wherein monomer 1A is substantially insoluble in solution 2, and monomer 2B is substantially insoluble in solution 1, thereby forming a fluoropolymer film at the bilayer interface; wherein the repeating unit of the fluoropolymer film is formed from monomer 1A and monomer 2B covalently bonded together, and the fluoropolymer film has a thickness of about 0.1 nm to about 1000 nm and an area to thickness aspect ratio of about 10⁴ to about 10¹⁴.

The disclosure also provides novel compounds of Formulas I-IV, intermediates for the synthesis of compounds of Formulas I-IV, as well as methods of preparing compounds of Formulas I-IV. The disclosure also provides compounds of Formulas I-IV that are useful as intermediates for the synthesis of other useful compounds. The disclosure provides for the use of compounds of Formulas I-IV for the manufacture of polymer films and polymer monolayers.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. General reaction for the preparation of ultra-thin polymeric and COF films at the liquid-liquid interfaces.

FIG. 2. Example of synthesis of large area free standing ultra-thin 2D PFA-COF-1 thin film at the liquid-liquid interface. Reaction performed at room temperature for 48 hours and photographed with room lighting without camera flash.

FIG. 3A-3C. Infrared spectra of PFA-COF-1 (a), corresponding precursors N-1 (b) and M-1 (c) on NaCl crystals. M-1 and N-1 were drop-casted on NaCl crystals.

FIG. 4. Left, picture of the PFA-COF-1 film formed at the HFE-7200 (bottom layer) and DMSO (top layer) interface, the small vial was tilted to show the film in the picture (with camera flash on). Right, picture of PFA-COF-1 film permeability test with addition of HFE-7200 droplets onto the film residing at the interface (with camera flash off, but sample was under UV light to illustrate the HFE-7200 droplets with a HFE-7200 soluble blue fluorescence dye, 1,4,6,9-tetrakis-(heptadecafluorooctyl)anthracene).

FIG. 5A-5B. (a) SEM image of ultra-thin 2D PFA-COF-1 film on Si (100) wafer with 500× magnification. (b) Zoomed in image with 25,000× magnification of highlighted area in image (a). Film growing time: 28 hrs.

FIG. 6. AFM images of ultra-thin PFA-COF-1 film with 28 hrs growing time on Si (100) wafer and z direction profile analyses of two measured areas that are labeled as a) and b).

FIG. 7. The photo on the left demonstrates PFA-COF-1 formation when 1 mL solutions of M-1/HFE-7200 and N-1/DMSO are added carefully with syringes into a 3 mL vial, sealed, and stored in a dark, secure place. The photo on the right demonstrates PFA-COF-1 formation under nearly identical conditions as the film on the left, except the tube was covered with aluminum foil and stored on a test tube rack with two other samples.

FIG. 8A-8K. Photographs of permeability test. (A) HFE-7200/dye passing through the interface of a DMSO/HFE-7200 blank solution where there is no film present at the interface. (B)-(K): Photographs of PFA-COF-1 film with the addition of HFE-7200/dye solution being added through the DMSO/N-1 layer. (B)-(E) A dropwise addition of the HFE-7200/dye solution was added carefully with a microliter syringe. (F) Droplets merged at the edge of the PFA-COF-1 film. (G)-(I) The weight of the droplet exceeded the adhesive force of the PFA-COF-1 film and glass surface and slid into the HFE-7200 solution below through the edge of the film. (J) and (K) The remaining solution droplets, with no further addition of HFE-7200/dye, permeated into the HFE-7200 solution below the film. Pictures/video were taken under the UV light irradiation on to the sample vial which shows blue fluorescence of the HFE-7200/dye droplets.

FIG. 9. Photographs of the residual HFE-7200/dye solution resting on the PFA-COF-1 film with no further diffusion through the PFA-COF-1 film over the period of couple months. Pictures were taken under the room light condition without camera flash light and UV lamp irradiation to the sample.

FIG. 10. UV-Vis spectrum of PFA-COF-1 film on quartz slide.

FIG. 11. DSC-TGA analysis of PFA-COF-1 using a bulk synthesized sample (2.9950 mg). Note: the sudden mass change at 70° C. was due to possible strong vibration that causes small portion sample falling off the balance during the measurement.

FIG. 12. Drawing of the structure unit of PFA-COF-1.

FIG. 13. SEM image of PFA-COF-1 film, film growing time: 2 hours, SEM magnification 4.29K

FIG. 14. SEM image of PFA-COF-1 film, film growing time: 4 hours, SEM magnification 2.50K.

FIG. 15. SEM image of PFA-COF-1 film, film growing time: 6 hours, SEM magnification 100.

FIG. 16. SEM image of PFA-COF-1 film, film growing time: 24 hours, SEM magnification 100.

FIG. 17. SEM image of PFA-COF-1 film, film growing time: 26 hours, SEM magnification 100.

FIG. 18. SEM image of PFA-COF-1 film, film growing time: 28 hours, SEM magnification 500.

FIG. 19. SEM image of PFA-COF-1 film, film growing time: 48 hours, SEM magnification 100.

FIG. 20. SEM image of PFA-COF-1 film, film growing time: 50 hours, SEM magnification 100.

FIG. 21. SEM image of PFA-COF-1 film, film growing time: 48 hours. Left region: PFA-COF-1 film, right region: bare Si (100) wafer. Random small dots near the edge of the film are likely from the residual precursors trapped between the film and Si substrate which are hard to wash out.

FIG. 22. Zoom in region of FIG. 21. Left region: PFA-COF-1 film, right region: bare Si (100) wafer.

FIG. 23. Further zoom in region of FIG. 22. Left region: PFA-COF-1 film, right region: bare Si (100) wafer.

FIG. 24. SEM images of PFA-COF-1 film (26 hours growing time) before and after 98% H₂SO₄ treatment. Left: before treatment. Magnification: 100; Right after 30 minute treatment in 98% H₂SO₄ solution. Magnification: 100.

FIG. 25. SEM images of PFA-COF-1 film (28 hour growing time) before and after 70% HClO₄ treatment. Left: before treatment. Magnification: 500; Right: after 30 minute treatment in 70% HClO₄ solution. Magnification: 500.

FIG. 26. SEM images of PFA-COF-1 film (48 hours growing time) before and after Piranha solution (H₂O₂:H₂SO₄) treatment. Left: before treatment. Magnification: 100; Right after 30 minute treatment. Magnification: 100.

FIG. 27. SEM images of PFA-COF (50 hours growing time) before and after 1 M NaOH treatment. Left: before treatment. Magnification: 100; Right: after 30 minute treatment. Magnification: 500.

FIG. 28. AFM image of a PFA-COF-1 film (28 hour growing time) (highlighted area is discussed in the main text of this paper).

FIG. 29A-29D. SEM and AFM comparisons of PFA-COF-1 film (growing time 50 hours). Left: SEM image of PFA-COF-1 film. Magnification: 2,500. Highlight area are measured by AFM imaging; Right: AFM imaging of PFA-COF-1 film. Thickness profiles of both area (a) and (b) are shown below. Left figure: thickness profile of area a) in the AFM image; Right figure: thickness profile of area b) in the AFM image. The average thickness of PFA-COF-1 film calculated is 15.47 nm from area (a), and 15.52 nm from area (b) which are the same within the error range of the measurement. Film thickness is calculated from the relative distance between first and second peaks of the Gaussian distribution in both areas. Comparing to the film thickness of ˜6 nm for the 28 hour growing sample (FIG. 6), this result clearly indicates that the thicker PFA-COF-1 film was formed as a result of increasing film grow time.

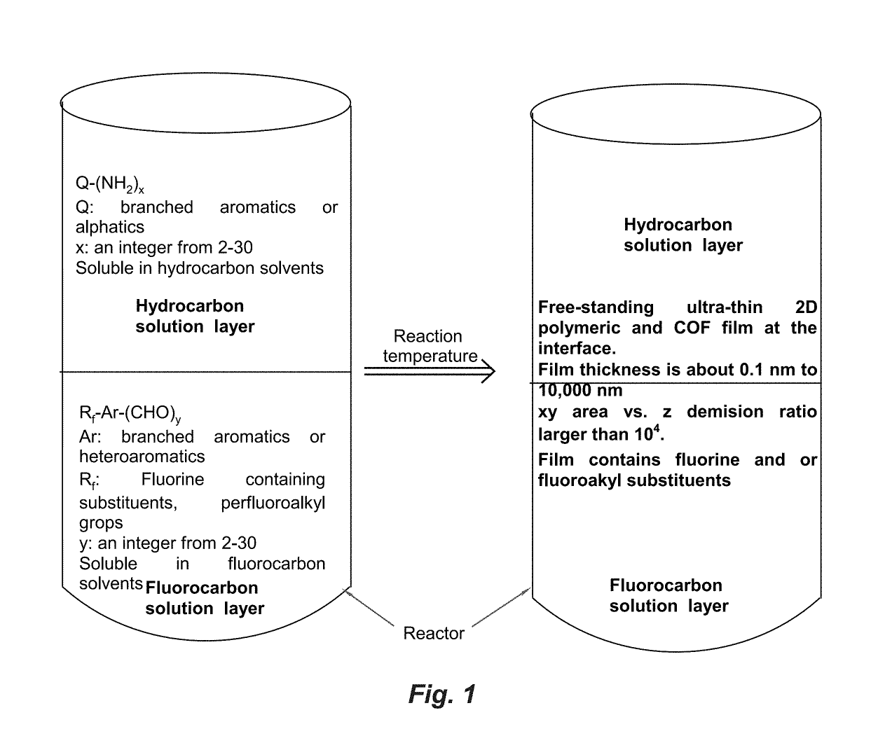

### DETAILED DESCRIPTION

In general, fluorocarbon solvents containing multiple Cₛₚ₃—F bonds are immiscible with hydrocarbon solvents at room temperature but miscible at elevated temperature. Such properties require the use of a highly reactive key precursor M-1 to bring the imine condensation reaction temperature down to room temperature. Precursor M-1 was successfully synthesized through a five-step procedure (Scheme 1) in a reasonably good yield. Compound M-1 was characterized by ¹H and ¹⁹F NMR, and MS. Detailed experimental procedure and characterization data are given in the Examples.

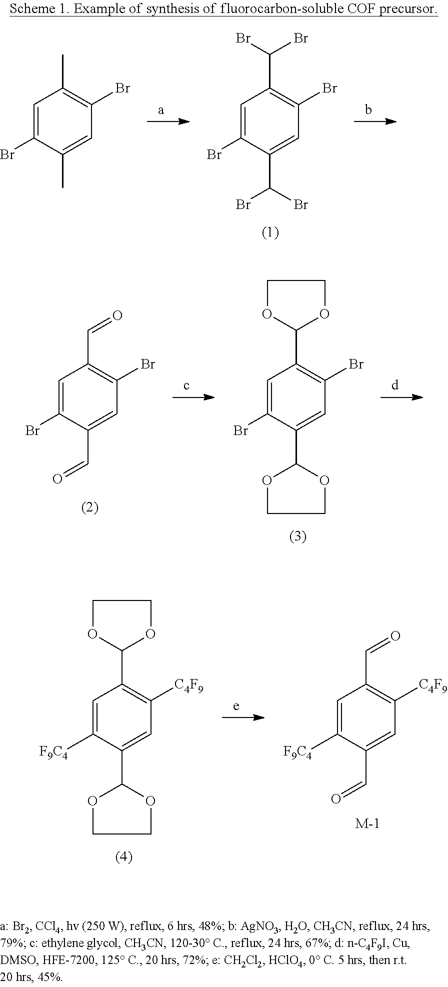

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%. For example, repeat unit A is substantially soluble (e.g., greater than about 95% or greater than about 99%) in a polar organic solvent and is substantially insoluble (e.g., less than about 5% or less than about 1%) in a fluorocarbon solvent. In another example, repeat unit B is substantially soluble (e.g., greater than about 95% or greater than about 99%) in a fluorocarbon solvent and is substantially insoluble (e.g., less than about 5% or less than about 1%) in a polar organic solvent.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

Further examples of useful organic solvents include any organic solvent in which the starting materials and reagents are sufficiently soluble to provide reaction products. Examples of such organic solvents may include ketones such as cyclohexanone and methyl amyl ketone; alcohols such as 3-methoxybutanol, 3-methyl-3-methoxybutanol, 1-methoxy-2-propanol, and 1-ethoxy-2-propanol; ethers such as propyleneglycol monomethyl ether, ethyleneglycol monomethyl ether, propyleneglycol monoethyl ether, ethyleneglycol monoethyl ether, propyleneglycol dimethyl ether, and diethyleneglycol dimethyl ether; esters such as propyleneglycol monomethyl ether acetate, propyleneglycol monoethyl ether acetate, ethyl lactate, ethyl pyruvate, butyl acetate, methyl 3-methoxypropionate, ethyl 3-ethoxypropionate, tert-butyl acetate, tert-butyl propionate, and propyleneglycol mono-tert-butyl ether acetate; and lactones such as γ-butyrolactone. These organic solvents may be used alone or in a mixture of two or more kinds thereof, but are not limited thereto.

As used herein, the term “substituted” or “substituent” is intended to indicate that one or more (for example, 1-20 in various embodiments, 1-10 in other embodiments, 1, 2, 3, 4, or 5; in some embodiments 1, 2, or 3; and in other embodiments 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound. Suitable indicated groups include, e.g., alkyl, alkenyl, alkynyl, alkoxy, halo, haloalkyl, hydroxy, hydroxyalkyl, aryl, heteroaryl, heterocycle, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfinyl, alkylsulfonyl, and cyano. Additionally, the suitable indicated groups can include, e.g., —X, —R, —O⁻, —OR, —SR, —S⁻, —NR₂, —NR₃, ═NR, —CX₃, —CN, —OCN, —SCN, —N═C═O, —NCS, —NO, —NO₂, ═N₂, —N₃, NC(═O)R, —C(═O)R, —C(═O)NRR —S(═O)₂O⁻, —S(═O)₂OH, —S(═O)₂R, —OS(═O)₂OR, —S(═O)₂NR, —S(═O)R, —OP(═O)O₂RR, —P(═O)O₂RR —P(═O)(O⁻)₂, —P(═O)(OH)₂, —C(═O)R, —C(═O)X, —C(S)R, —C(O)OR, —C(O)O⁻, —C(S)OR, —C(O)SR, —C(S)SR, —C(O)NRR, —C(S) NRR, —C(NR)NRR, where each X is independently a halogen (“halo”): F, Cl, Br, or I; and each R is independently H, alkyl, aryl, heterocycle, protecting group or prodrug moiety. As would be readily understood by one skilled in the art, when a substituent is keto (i.e., ═O) or thioxo (i.e., ═S), or the like, then two hydrogen atoms on the substituted atom are replaced. Another example of a substituent is a perfluorocarbon that refers to any organic moiety (e.g., less than 1000 Daltons) having more than one fluoro substituent such as a perfluoroalkyl, perfluoroaryl, or perfluoroheteroaryl. Said perfluorocarbon substituent may have some hydrogen substituents replaced with fluoro or all hydrogens replaced with fluoro.

The term “alkyl” refers to a branched or unbranched hydrocarbon having, for example, from 1-20 carbon atoms, and often 1-12, 1-10, 1-8, 1-6, or 1-4 carbon atoms. As used herein, the term “alkyl” also encompasses a “cycloalkyl”, defined below. Examples include, but are not limited to, methyl, ethyl, 1-propyl, 2-propyl (isopropyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with a substituent described below. The alkyl can also be optionally partially or fully unsaturated. As such, the recitation of an alkyl group can include both alkenyl and alkynyl groups. The alkyl can be a monovalent hydrocarbon radical, as described and exemplified above, or it can be a divalent hydrocarbon radical (i.e., an alkylene).

The term “cycloalkyl” refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like. The cycloalkyl can be unsubstituted or substituted. The cycloalkyl group can be monovalent or divalent, and can be optionally substituted as described for alkyl groups. The cycloalkyl group can optionally include one or more sites of unsaturation, for example, the cycloalkyl group can include one or more carbon-carbon double bonds, such as, for example, 1-cyclopent-1-enyl, 1-cyclopent-2-enyl, 1-cyclopent-3-enyl, cyclohexyl, 1-cyclohex-1-enyl, 1-cyclohex-2-enyl, 1-cyclohex-3-enyl, and the like.

The term “aromatic” refers to an aryl or heteroaryl group or an aryl or heteroaryl substituent described herein.

The term “aryl” refers to an aromatic hydrocarbon group derived from the removal of at least one hydrogen atom from a single carbon atom of a parent aromatic ring system. The radical attachment site can be at a saturated or unsaturated carbon atom of the parent ring system. The aryl group can have from 6 to 30 carbon atoms, for example, about 6-10 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted.

The term “heteroaryl” refers to a monocyclic, bicyclic, or tricyclic ring system containing one, two, or three aromatic rings and containing at least one nitrogen, oxygen, or sulfur atom in an aromatic ring. The heteroaryl can be unsubstituted or substituted, for example, with one or more, and in particular one to three, substituents, as described in the definition of “substituted”. Typical heteroaryl groups contain 2-20 carbon atoms in the ring skeleton in addition to the one or more heteroatoms. Examples of heteroaryl groups include, but are not limited to, 2H-pyrrolyl, 3H-indolyl, 4H-quinolizinyl, acridinyl, benzo[b]thienyl, benzothiazolyl, β-carbolinyl, carbazolyl, chromenyl, cinnolinyl, dibenzo[b,d]furanyl, furazanyl, furyl, imidazolyl, imidizolyl, indazolyl, indolisinyl, indolyl, isobenzofuranyl, isoindolyl, isoquinolyl, isothiazolyl, isoxazolyl, naphthyridinyl, oxazolyl, perimidinyl, phenanthridinyl, phenanthrolinyl, phenarsazinyl, phenazinyl, phenothiazinyl, phenoxathiinyl, phenoxazinyl, phthalazinyl, pteridinyl, purinyl, pyranyl, pyrazinyl, pyrazolyl, pyridazinyl, pyridyl, pyrimidinyl, pyrrolyl, quinazolinyl, quinolyl, quinoxalinyl, thiadiazolyl, thianthrenyl, thiazolyl, thienyl, triazolyl, tetrazolyl, and xanthenyl. In one embodiment the term “heteroaryl” denotes a monocyclic aromatic ring containing five or six ring atoms containing carbon and 1, 2, 3, or 4 heteroatoms independently selected from non-peroxide oxygen, sulfur, and N(Z) wherein Z is absent or is H, O, alkyl, aryl, or (C₁-C₆)alkylaryl. In some embodiments, heteroaryl denotes an ortho-fused bicyclic heterocycle of about eight to ten ring atoms derived therefrom, particularly a benz-derivative or one derived by fusing a propylene, trimethylene, or tetramethylene diradical thereto.

The phrase “one or more” is readily understood by one of skill in the art, particularly when read in context of its usage. For example, one or more substituents on a phenyl ring refers to one to five, or one to up to four, for example if the phenyl ring is disubstituted. One or more subunits (i.e., repeat units or blocks) of a polymer can refer to about 5 to about 500,000,000 or any number of subunits to obtain an aspect ratio of about 10⁴ to about 10²⁰.

Substituents of the compounds and polymers described herein may be present to a recursive degree. In this context, “recursive substituent” means that a substituent may recite another instance of itself. Because of the recursive nature of such substituents, theoretically, a large number may be present in any given claim. One of ordinary skill in the art of medicinal chemistry and organic chemistry understands that the total number of such substituents is reasonably limited by the desired properties of the compound intended. Such properties include, by example and not limitation, physical properties such as molecular weight, solubility or log P, application properties such as activity against the intended target, and practical properties such as ease of synthesis. Recursive substituents are an intended aspect of the invention. One of ordinary skill in the art of medicinal and organic chemistry understands the versatility of such substituents. To the degree that recursive substituents are present in a claim of the invention, the total number in the repeating unit of a polymer example can be, for example, about 1-50, about 1-40, about 1-30, about 1-20, about 1-10, or about 1-5.

The term “monolayer” as used herein refers to a polymer film that is one molecule thick (i.e., the polymer's shortest physical dimension), and preferably does not have folds or overlapping layers, or is substantially free of folds or overlapping layers. The film or monolayer can be isolated on a substrate such as, but not limited to a silicon wafer, by (for example) lowering the film onto the substrate. The film may comprise pores, the size depending on, for example, the opening of a macrocyclic repeating unit, through which small molecules can pass, thereby rendering the film porous.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer film or monolayer.

### Embodiments of the Invention

This disclosure describes various embodiments of a fluoropolymer film comprising:

a) a repeat unit A, wherein a monomer 1A that forms repeat unit A is soluble in a polar organic solvent and is substantially insoluble in a fluorocarbon solvent; and

b) a repeat unit B, wherein a monomer 2B that forms repeat unit B is soluble in the fluorocarbon solvent and is substantially insoluble in the polar organic solvent, and wherein repeat unit B and monomer 2B are substituted with a perfluorocarbon substituent;

wherein a combined repeating unit of the fluoropolymer film comprises repeat unit A and repeat unit B covalently bonded together, and the fluoropolymer film has a thickness of about 0.1 nm to about 10,000 nm and an area to thickness aspect ratio of about 10³ to about 10¹⁴.

In other embodiments of the disclosure, the aspect ratio is up to about 10⁴, about 10⁵, about 10⁶, about 10⁷, about 10⁸, about 10⁹, about 10¹⁰, about 10¹¹, about 10¹², about 10¹³, about 10¹⁴, about 10¹⁵, about 10¹⁶, about 10¹⁷, about 10¹⁸, about 10¹⁹, or about 10²⁰. In some additional embodiments, the perfluorocarbon substituent is a perfluoroalkyl substituent. In additional embodiments, the perfluoroalkyl substituent is Formula I:

—(CH₂)ₘ—(CF₂)ₙ—CF₃ (I);

wherein m is 0-30; and n is 0-30.

In additional embodiments, monomer 1A is aromatic monomer 1A having one or more substituents, and monomer 2B is aromatic monomer 2B having two or more substituents, wherein aromatic monomer 1A and aromatic monomer 2B form the combined repeating unit of the fluoropolymer film. In other embodiments, aromatic monomer 1A, or aromatic monomer 2B, is a phenyl, pyrene, naphthalene, anthracene, coronene, furan, pyridine, pyrazine, pyrimidine, indole, imidazole, oxazole, phenanthroline, phthalocyanine, porphyrin, metallophthalocyanine, or metalloporphyrine. In some additional embodiments, each substituent on aromatic monomer 1A or aromatic monomer 2B is independently halo, alkyl, amino, imine, hydroxyl, carbaldehyde, carboxyl, sulfonyl, phosphoryl, phenyl, aryl, heteroaryl, or a combination thereof, and wherein phenyl, aryl or heteroaryl are optionally substituted with one or more said substituents. In yet other embodiments, the substituent is halo, amino, carbaldehyde, or phenyl.

In various embodiments, monomer 1A that forms repeat unit A is Formula II:

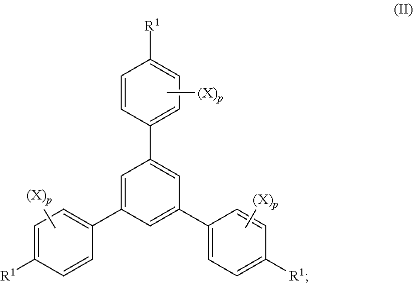

wherein

R¹ is OH or NH₂; each X is independently F, Cl, Br, CH₃, CH₂CH₃, OH, NH₂, or C(O)OH; and each p is independently 0-4.

In various additional embodiments, the monomer 2B that forms repeat unit B is Formula III:

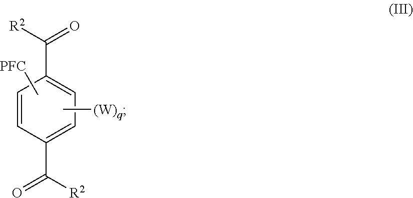

wherein R² is H, OH, alkyl, or aryl; PFC is a perfluorocarbon; each W is independently F, Cl, Br, CH₃, CHF₂, CF₃, CH₂CH₃, or PFC; and q is 0-3.

In other various embodiments, the combined repeating unit comprises Formula IV:

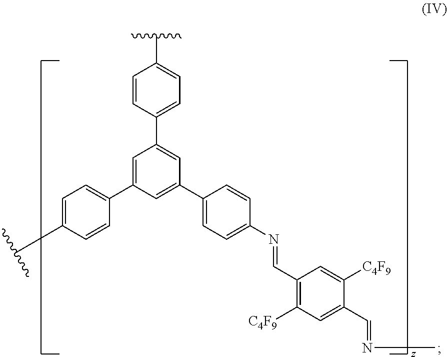

wherein z is >1; and z is bonded to an additional z through a C—N bond.

In other additional embodiments, the fluoropolymer film has a thickness of about 0.1 nm to about 1,000 nm and an area to thickness aspect ratio of about 10⁴ to about 10¹⁰. In some other embodiments, the fluoropolymer film is in the form of a fluoropolymer monolayer. In additional embodiments, the fluoropolymer film is porous. In various embodiments of this disclosure, the pore size is less than about 500 μm, 250 μm, 100 μm, 50 μm, 10 μm, 1 μm, 0.1 μm, 0.01 μm, 0.001 μm, or 0.0001 μm. In other embodiments, the pore size is about 1 nm to about 2000 nm, about 1 nm to about 1000 nm, about 5 nm to about 1000 nm, about 5 nm to about 100 nm, or about 1 nm to about 100 nm.

This disclosure provides various embodiments of a fluoropolymer monolayer comprising:

a) an aromatic repeat unit A, wherein an amino substituted monomer 1A that forms repeat unit A is soluble in a polar organic solvent and is substantially insoluble in a fluorocarbon solvent; and

b) an aromatic repeat unit B, wherein a carbaldehyde substituted monomer 2B that forms repeat unit B is soluble in the fluorocarbon solvent and is substantially insoluble in the polar organic solvent, and wherein repeat unit B and monomer 2B are substituted with a perfluorocarbon substituent;

wherein a combined repeating unit of the fluoropolymer monolayer comprises repeat unit A and repeat unit B covalently bonded together via an imine linkage, and the fluoropolymer monolayer has a thickness of about 0.1 nm to about 100 nm, and an area to thickness aspect ratio of about 10⁴ to about 10¹⁰.

This disclosure also provides embodiments of a method of preparing a fluoropolymer film comprising:

a) dissolving monomer 1A in a polar organic solvent to form solution 1;

b) dissolving monomer 2B in a fluorocarbon solvent to form solution 2; and

c) combining solution 1 and solution 2 to form a bilayer interface wherein solution 1 and solution 2 are substantially immiscible with each other, thereby forming a fluoropolymer film at the bilayer interface.

In various embodiments, a method of preparing a fluoropolymer film comprises:

a) dissolving an aromatic monomer 1A in a polar organic solvent to form solution 1;

b) dissolving an aromatic monomer 2B in a fluorocarbon solvent to form solution 2, wherein monomer 2B has at least one perfluorocarbon substituent; and

c) combining solution 1 and solution 2 to form a bilayer interface wherein solution 1 and solution 2 are substantially immiscible with each other, wherein monomer 1A is substantially insoluble in solution 2, and monomer 2B is substantially insoluble in solution 1, thereby forming a fluoropolymer film at the bilayer interface;

wherein the repeating unit of the fluoropolymer film is formed from monomer 1A and monomer 2B covalently bonded together, and the fluoropolymer film has a thickness of about 0.1 nm to about 1000 nm and an area to thickness aspect ratio of about 10⁴ to about 10¹⁴.

In additional embodiments, the polar organic solvent is dimethyl sulfoxide (DMSO), dimethyl formamide (DMF), N-methyl-2-pyrolidinone (NMP), or acetonitrile (ACN). In other additional embodiments, the fluorocarbon solvent is a hydrofluoroether, perfluoropolyether, perfluorocarbon, or a combination thereof. For example, the fluorocarbon solvent can be, but is not limited to, ethoxy-nonafluorobutane (C₄F₉OC₂H₅; HFE-7200), methoxy-nonafluorobutane (C₄F₉OCH₃; HFE-7100), 2-(Trifluoromethyl)-3-ethoxydodecafluorohexane (HFE-7500), perfluoropentane, perfluorohexane, perfluorohepteane, perfluorooctane, perfluoromethylcyclohexane, perfluorodecalin, or a combination of said examples thereof. In some other embodiments, the perfluorocarbon substituent is —C₄F₉, —C₆F₁₃, —C₈F₁₇, or —C₁₂F₂₅. In other embodiments the perfluorocarbon can vary in the number of carbons and fluoros from —C₄F₉ to —C₁₂F₂₅. In additional embodiments, the perfluorocarbon substituent can be linear, branched, or isomers of —C₄F₉ to —C₁₂F₂₅. In various other embodiments, the fluoropolymer film is a porous monolayer.

In some embodiments, a two-dimensional polymeric or covalent organic framework thin film comprises perfluoroalkyl substituents formed at a fluorocarbon and hydrocarbon liquid-liquid interface, wherein said film has a thickness of between 0.1 nm and 10,000 nm and a xy area to z dimension aspect ratio equal to or above 10⁴. In other embodiments, the perfluoroalkyl groups have a formula of —(CH₂)ₘ—(CF₂)ₙCF₃ where m is 0-30 and n is 0-30, and m and n are independent from each other.

In some other embodiments, a method for the production of polymeric or covalent organic framework thin film comprises the use of a fluorocarbon and hydrocarbon interface as the only reaction center by utilizing fluorocarbon-soluble and hydrocarbon-soluble reagents that can only be dissolved in one of respective solvents. In other embodiments, the film is grown at the liquid-liquid interface at a temperature between the melting point of one of the higher melting point solvent and the boiling point of one of the lower boiling point solvent in the corresponding immiscible solvent pairs.

In some additional embodiments, the disclosed method further comprises the use of monomers or precursors that are aromatics with multiple —NH₂ functional groups and multiple —CHO groups. In yet other embodiments, the aromatics are polyaromatic hydrocarbons including but not limited to benzene, pyrene, naphthalene, anthracene, coronene, or can be heterocyclic organic compounds including but not limited to phenanthroline, phthalocyanine and metallophthalocyanine, porphyrin and metalloporphyrine.

This disclosure provides ranges, limits and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above in this disclosure.

### Results and Discussion

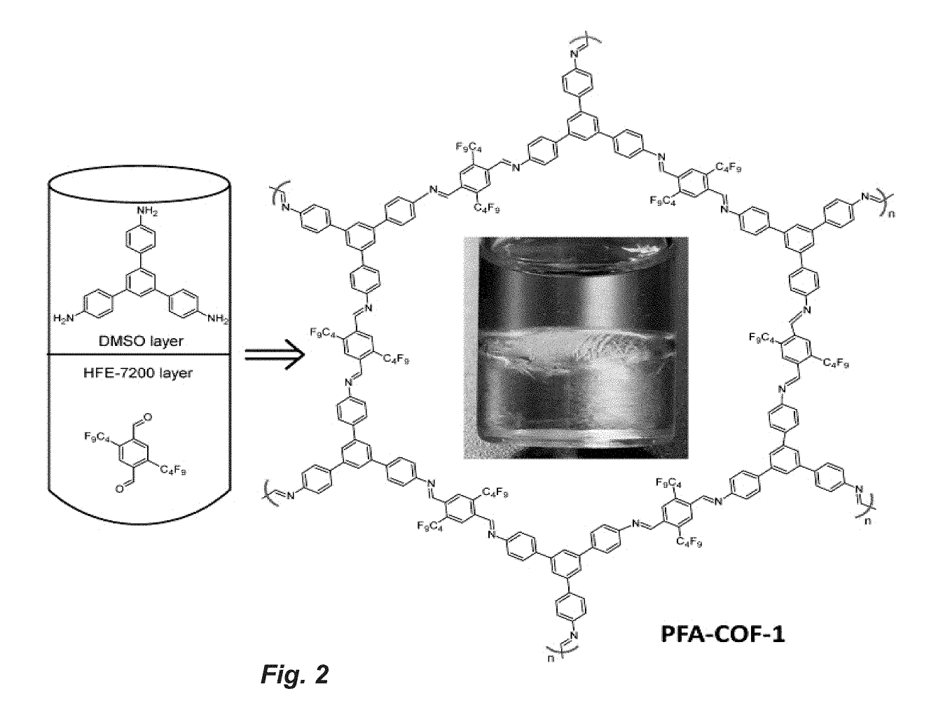

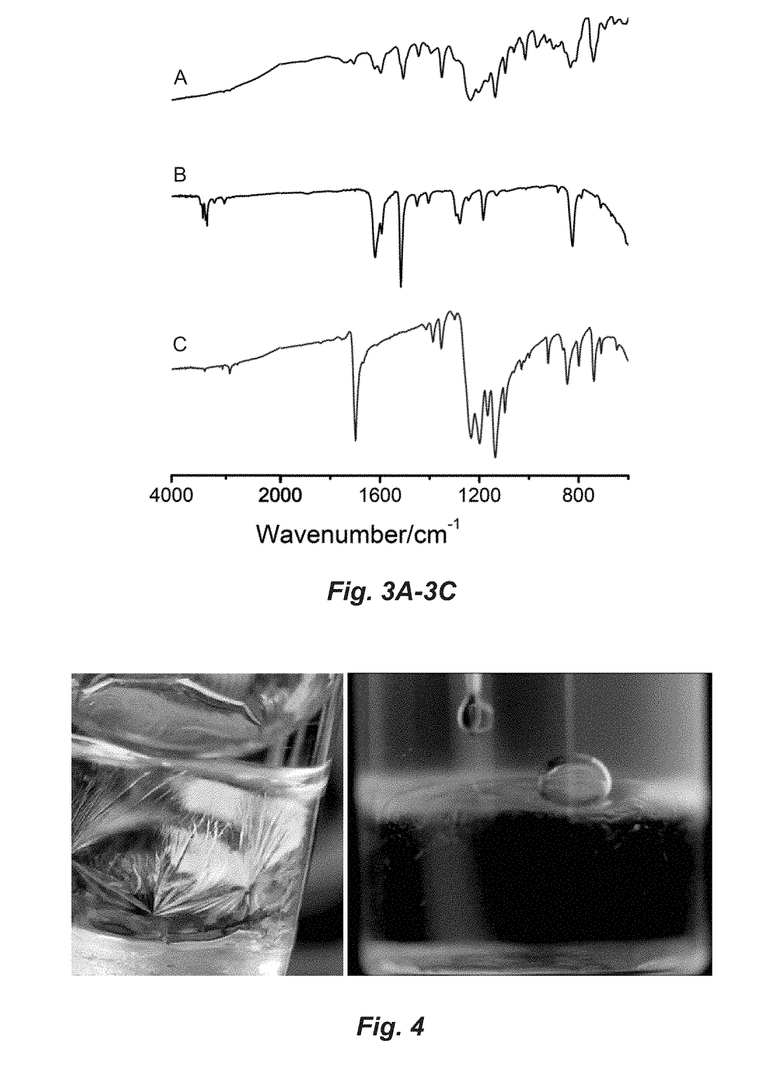

To gain optimized reaction conditions for preparing the large area free standing perfluoroalkylated COF thin film (FIG. 2, PFA-COF-1), we initially synthesized this 2D COF in its bulk form from a CHCl₃ solution where both precursors are reasonably soluble. The bulk materials formed during the condensation reaction are insoluble in both hydrocarbon and fluorocarbon solvents. Monitoring the reaction progress by ¹H and ¹⁹F NMR spectroscopy clearly shows the disappearance of both precursors' signal and formation of insoluble white solid product in NMR tubes. The infrared spectra (FIG. 3) of the product on NaCl IR window clearly shows strong yet broad Cₛₚ₃—F bond stretching vibration peaks around 1200 cm⁻¹, and C═N double bond stretching vibration peaks at 1600 cm⁻¹. M-1's characteristic C═O stretching vibration peak at 1698 cm⁻¹ and NA's characteristic N—H stretching vibration peaks at 3431, 3352, and 3200 cm⁻¹ from the —NH₂ groups were not observed. These observations indicate the formation of PFA-COF-1 with a large molecular mass.

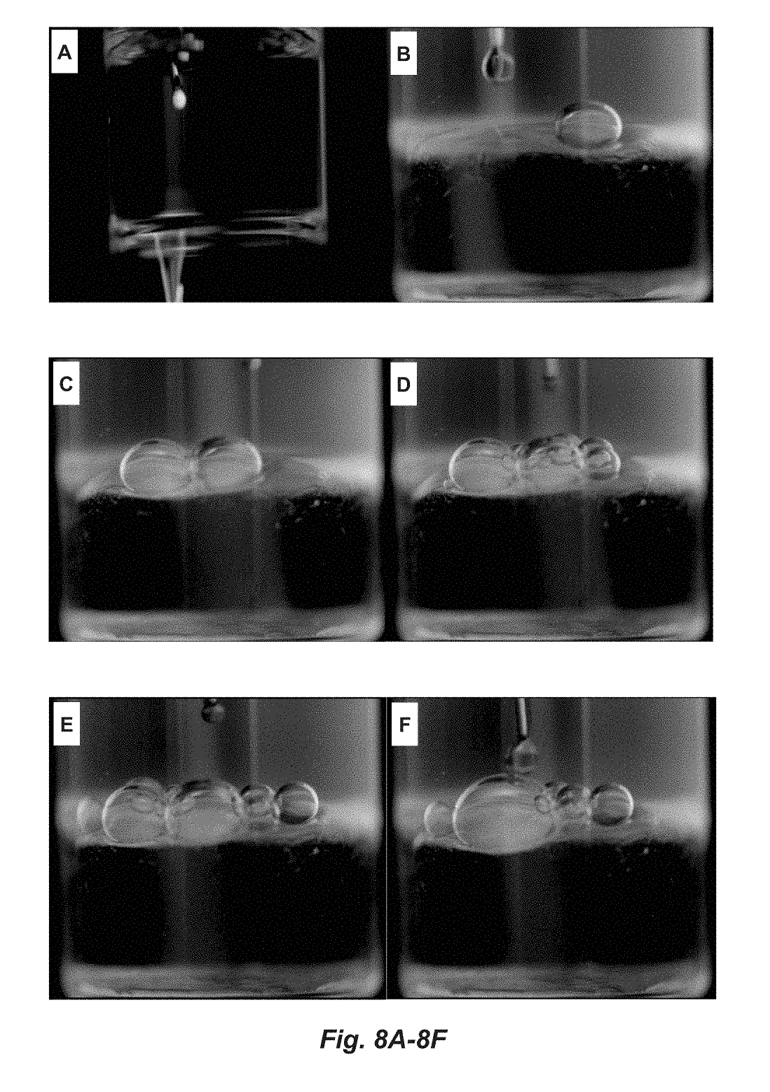

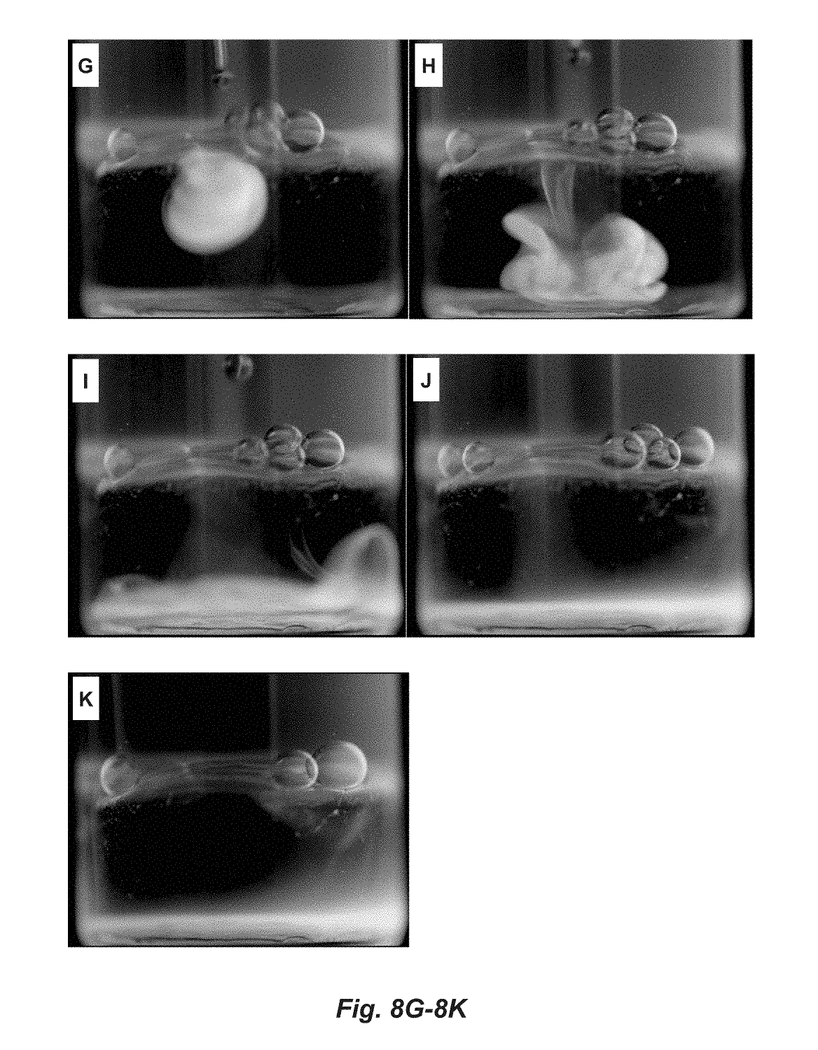

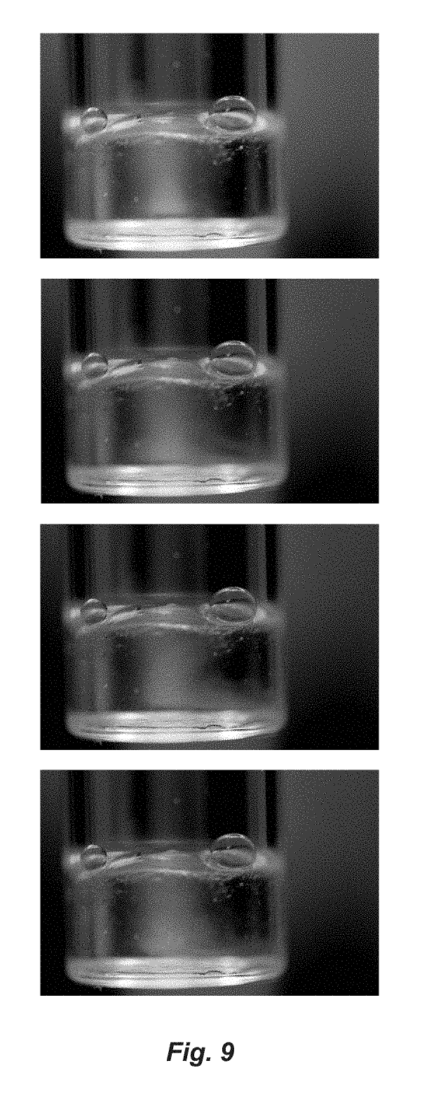

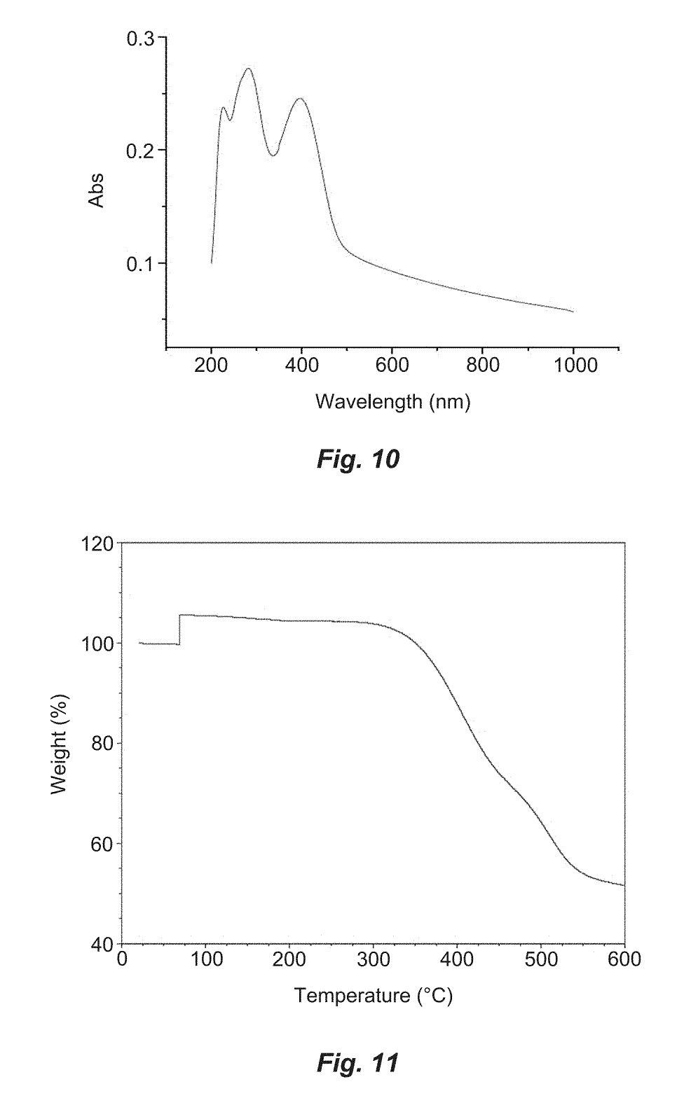

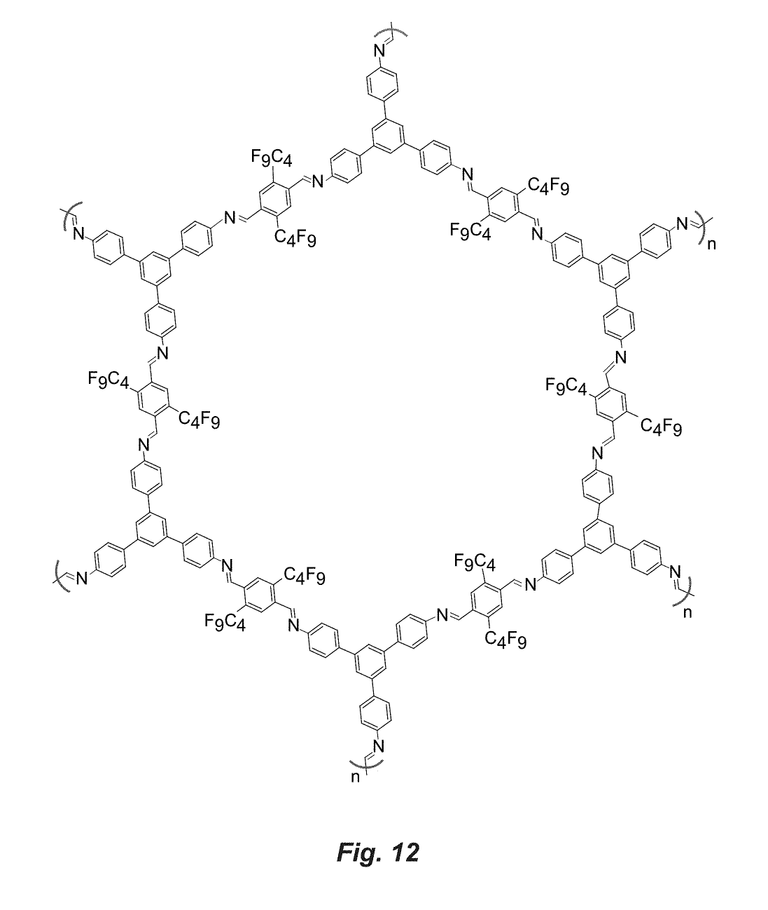

The formation of PFA-COF-1 product in bulk solution prompted us to proceed with the preparation of large area free standing ultra-thin PFA-COF-1 film at the liquid-liquid interface. A 2.0 mM N-1 DMSO solution was carefully placed on top of 2.0 mM M-1 HFE-7200 solution in a test tube or a small vial, and the reaction proceeded at room temperature (20±2° C.) in a dark place away from any strong vibration. Typically, thin-film formation was clearly observed by the naked eye at the DMSO/HFE-7200 interface after 24 to 48 hrs (FIG. 4). The thin film formed after 48 hrs is strong enough to hold multiple HFE-7200 droplets without letting the HFE-7200 droplets permeate through the film and mix with the bottom HFE-7200 layer. The blank test showed HFE-7200 droplets going through the DMSO/HFE-7200 interface right away (FIG. 8 and FIG. 9). The formed thin-film PFA-COF-1 was caught on various substrates such as: Si wafer (100), ITO glass, NaCl crystal, gold mesh, and quartz slides for further characterization by preplacing the substrates into the reaction vial before setting up the reaction and pulling them out after the film formation. The film on the substrates was carefully washed with dichloromethane and dried in the 70° C. oven before proceeding with further characterization by SEM, AFM, UV-visible absorption, and FTIR spectroscopy.

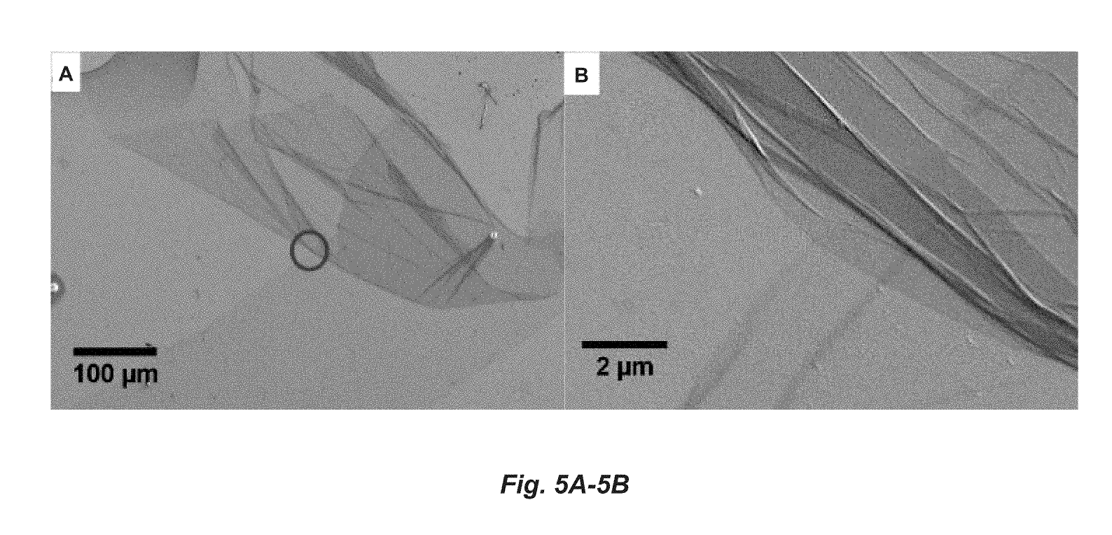

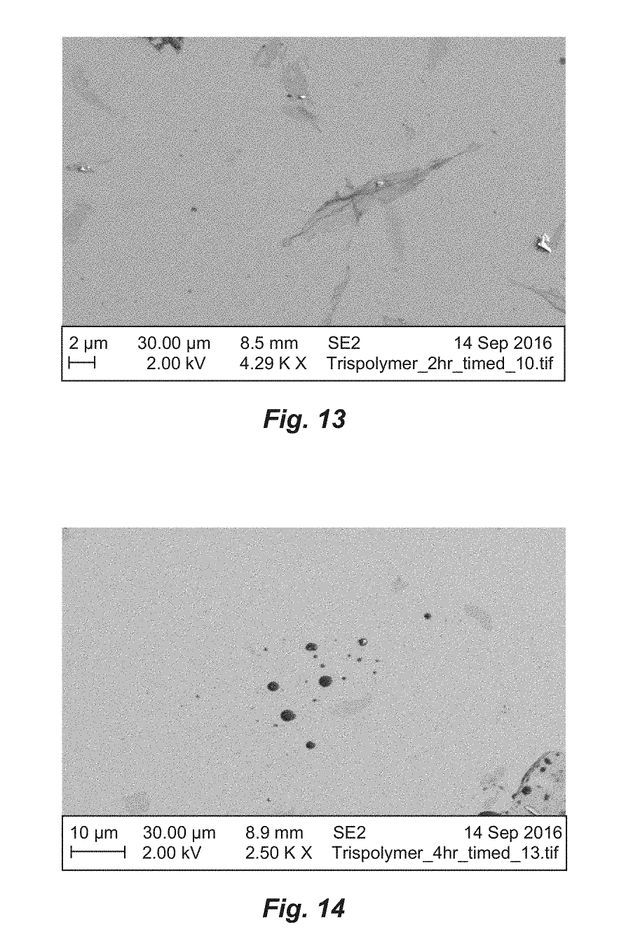

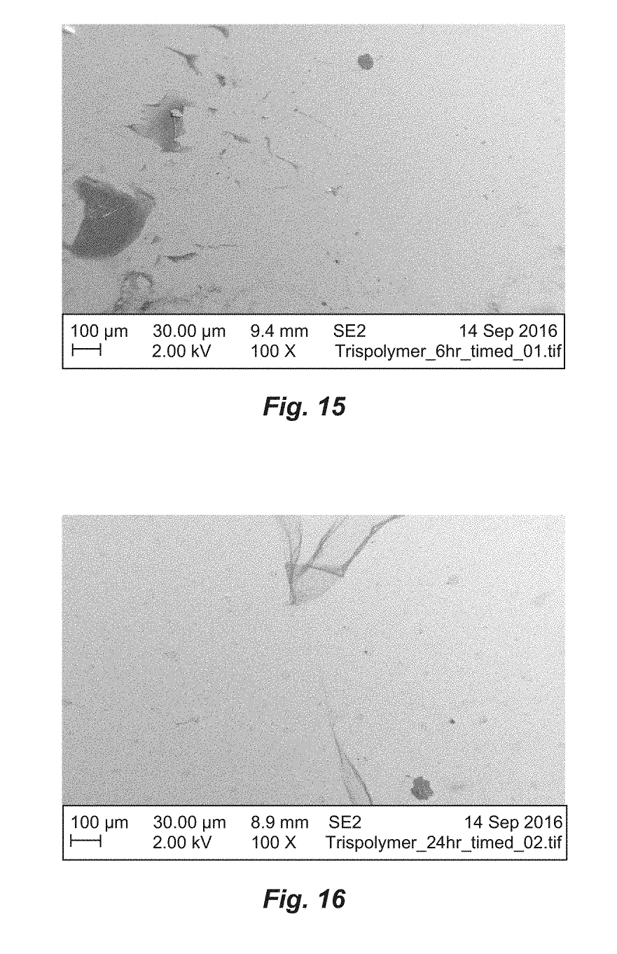

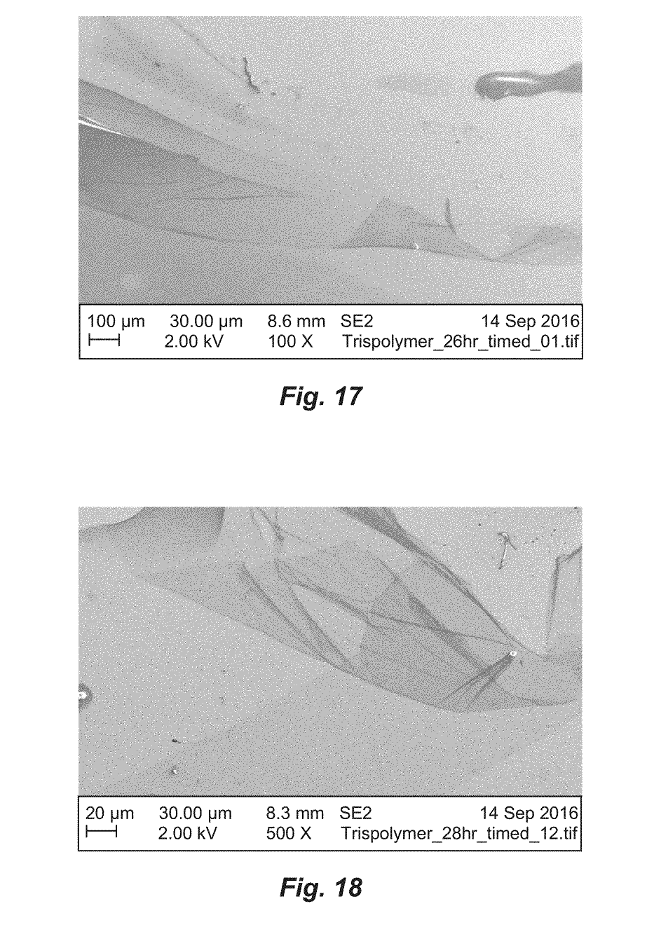

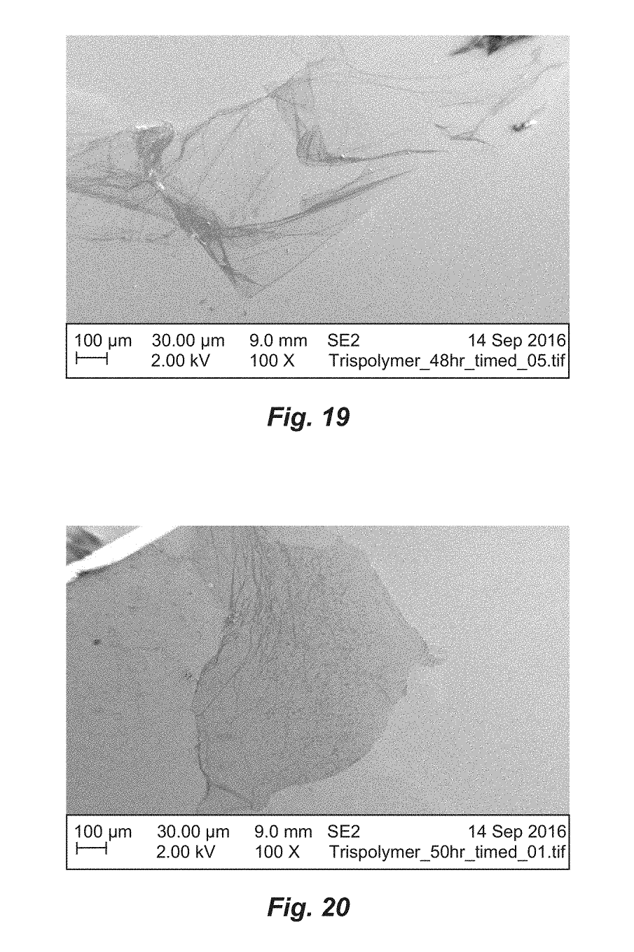

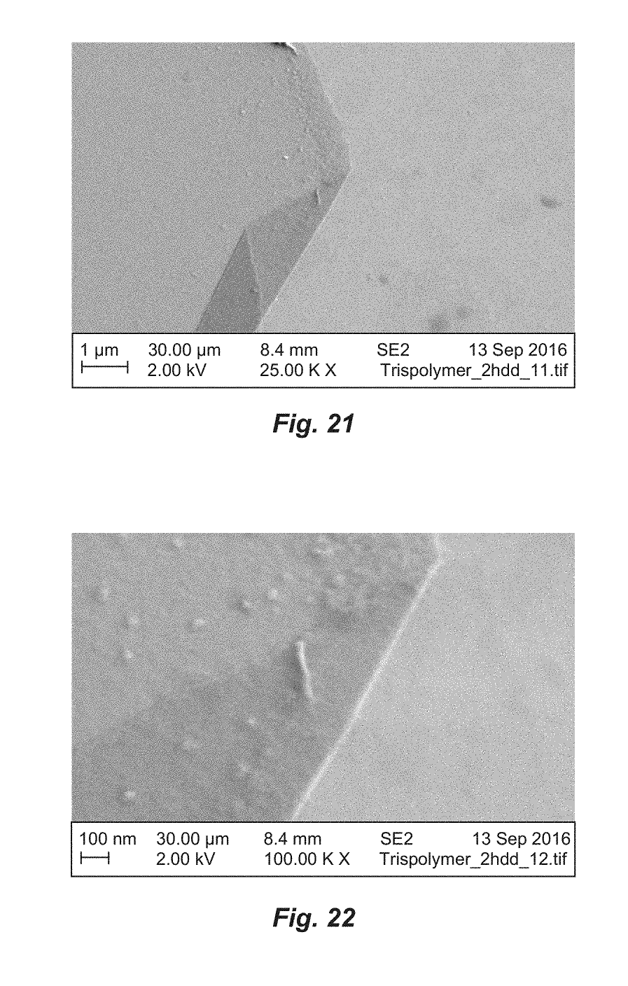

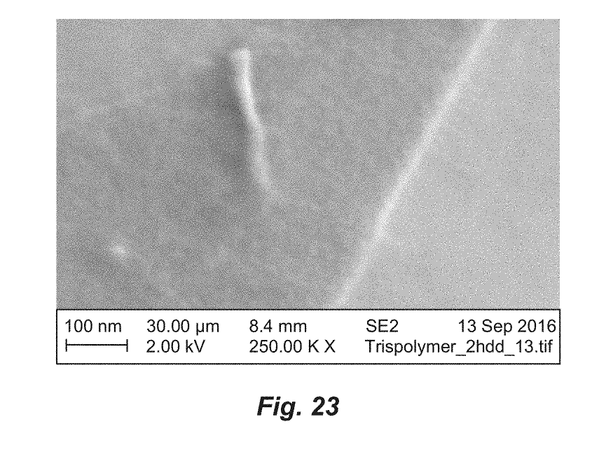

Scanning electronic microscopy (SEM) images of the ultra-thin 2D PFA-COF-1 film with 28 hrs growing time on Si (100) wafer with different magnifications are shown in FIG. 5. A large area of thin film with size of around 1 mm² on a silicon wafer was observed. It is fairly easy to observe the contrast differences between the bare substrate, single layered PFA-COF-1 film, double- or multi-layered folded PFA-COF-1 films, and wrinkled PFA-COF-1 film (FIG. 5a). Higher magnification SEM images (FIG. 5b, FIG. 21, FIG. 22 and FIG. 23) clearly exhibit that PFA-COF-1 films are smooth with very low surface roughness. The wrinkled areas of the PFA-COF-1 are perhaps due to the solvent rinsing procedure during the wash processes. To optimize the thin film growing condition for PFA-COF-1, we collected SEM images for a series of PFA-COF-1 film on Si(100) wafers that formed over a period of time from 2 hrs to 50 hrs. The SEM images indicated that the PFA-COF-1 thin film started to form after 6 hours of reaction time, and the size of PFA-COF-1 thin film increases with increasing the film growing time (FIGS. 13-20).

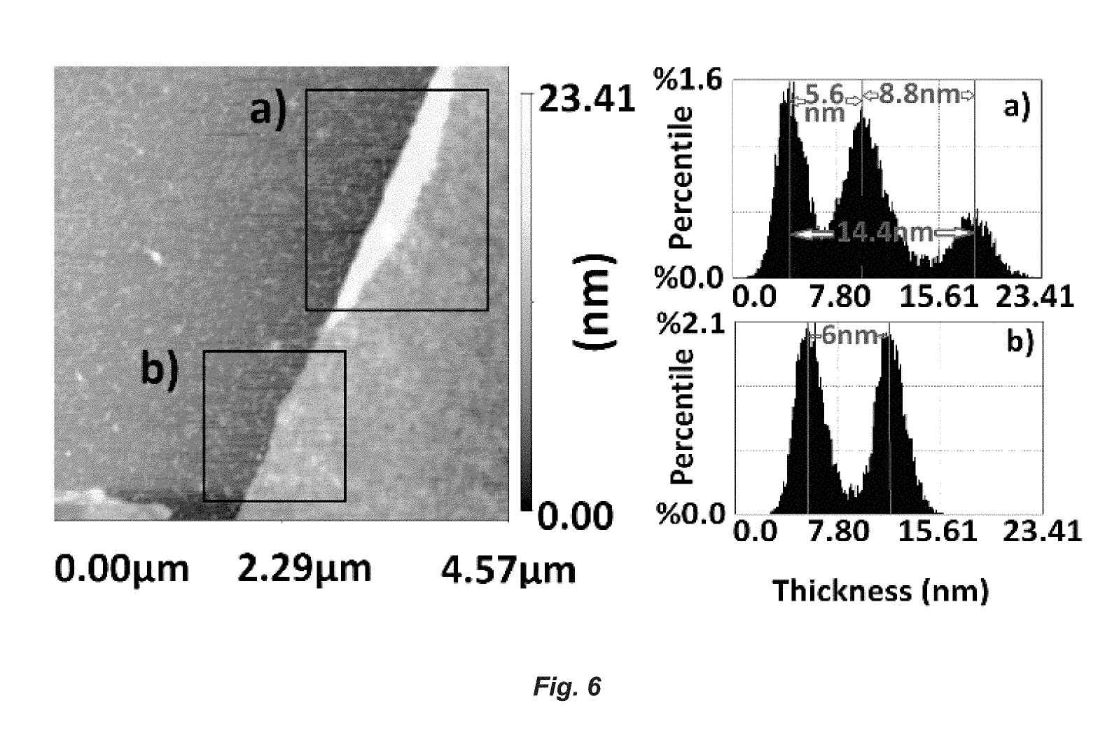

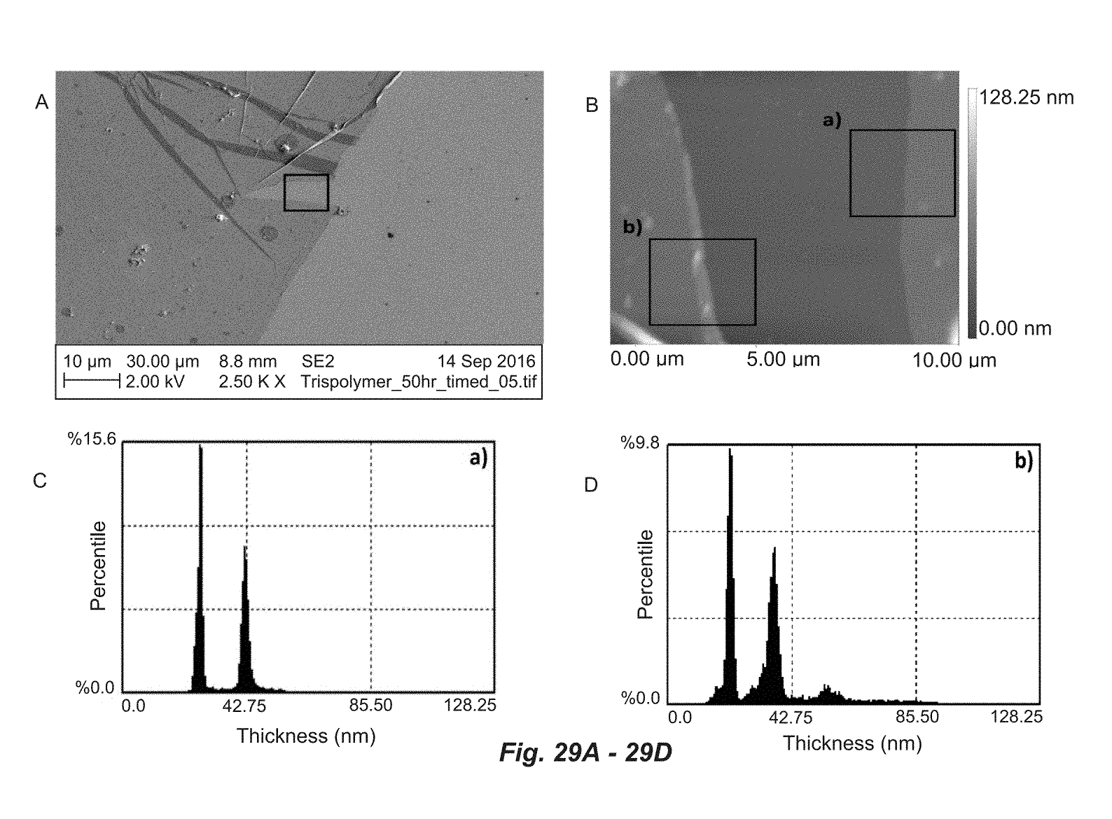

Though SEM images provide powerful information regarding the PFA-COF-1 thin film morphology, the thickness of the film is hard to be determined directly from the SEM images. We conducted atomic force microscopy (AFM) to characterize the morphology and, in particular, the thickness of the PFA-COF-1 thin films. To better compare the SEM and AFM results, we used the same batch of SEM samples to collect the AFM images and the film thickness profiles were determined through Gaussian distribution analyses. SEM results indicate that PFA-COF-1 thin film is smooth, but wrinkled and folded areas were observed. This observation was further confirmed by AFM results (FIG. 6). Area (a) in an AFM image shows a region of folded PFA-COF-1 film, single layer PFA-COF-1 film, and bare substrate; and area (b) shows a clear edge between single layer PFA-COF-1 film and the bare substrate. Thickness profiles of area (a) and (b) indicate that film thickness is close to Gaussian distribution. The average thickness of single layer PFA-COF-1 film calculated from area (a) is 5.6 nm (relative distance between first and second peaks of the Gaussian distribution) and 6.0 nm from area (b). While the small folded area in area (a) is 14.4 nm higher than the bare Si wafer surface, a calculated average thickness of single layer polymer is given as 7.2 nm which is slightly higher than the average thickness of 5.8 nm obtained above. Given the consideration of potential nonperfect packing in the small folded area, we can reasonably estimate that this PFA-COF-1 thin film is about 6 nm thick. The 8.8 nm difference in z profile between third and second peak of area (a) is slightly higher than the average thickness of single layer film (6 nm) is possibly because the folded film in area (a) may not be in close contact. The PFA-COF-1 film obtained after 50 hrs of film growing time is about 15.5 nm thick (FIG. 29). Side-by-side comparison of SEM and AFM images of the same sample and same area indicates that the film is uniformly formed throughout very large area at the liquid-liquid interface (FIG. 29). The low magnification SEM and AFM results tell us that the ratio of XY dimensions to Z dimension of the thin film is at least 10¹⁰, providing potential opportunity to integrate millions, if not billions, of molecular electronic circuits together.

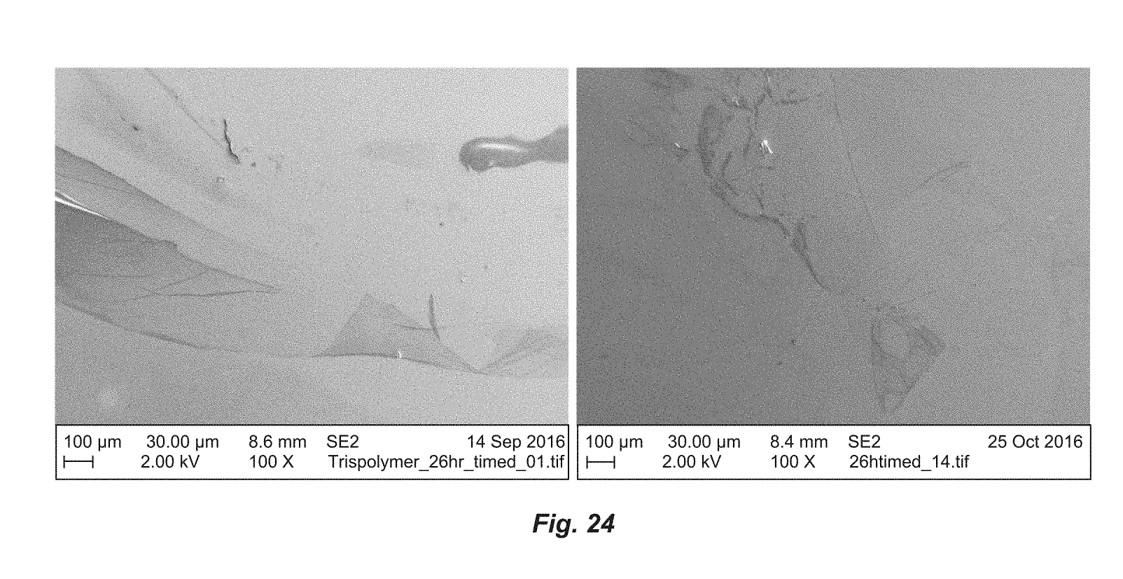

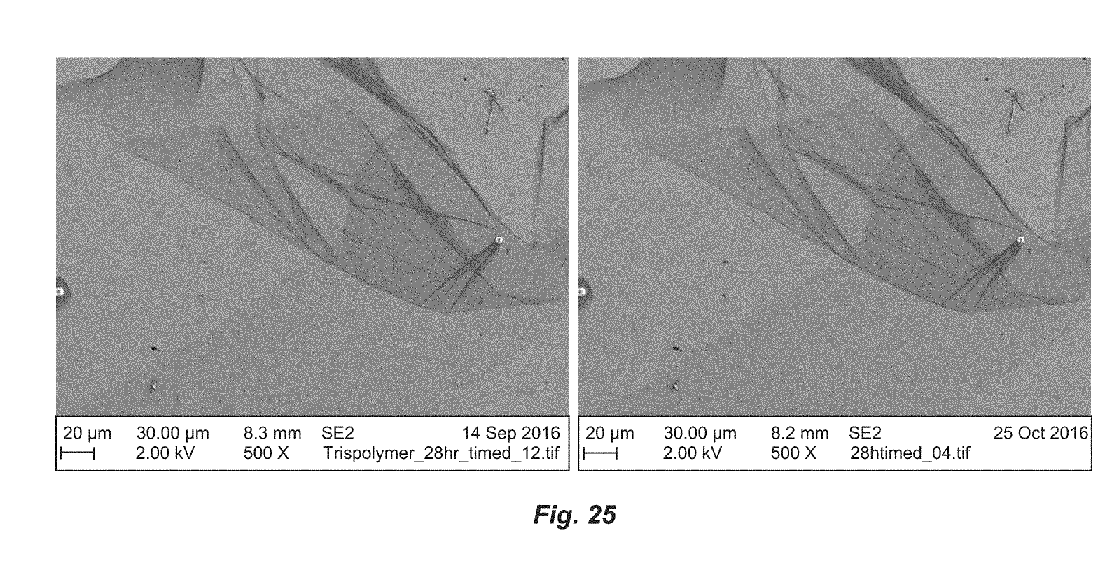

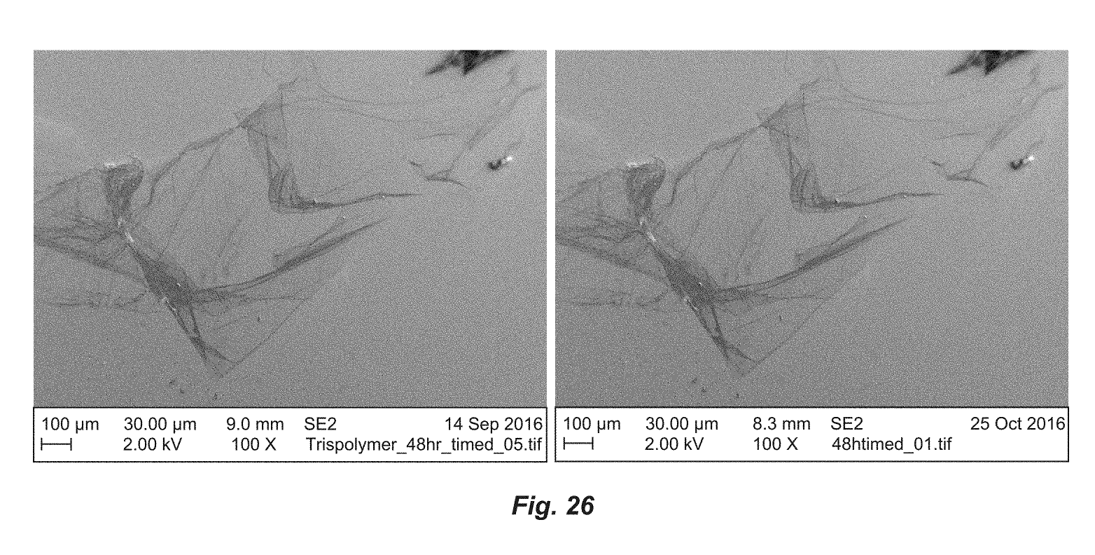

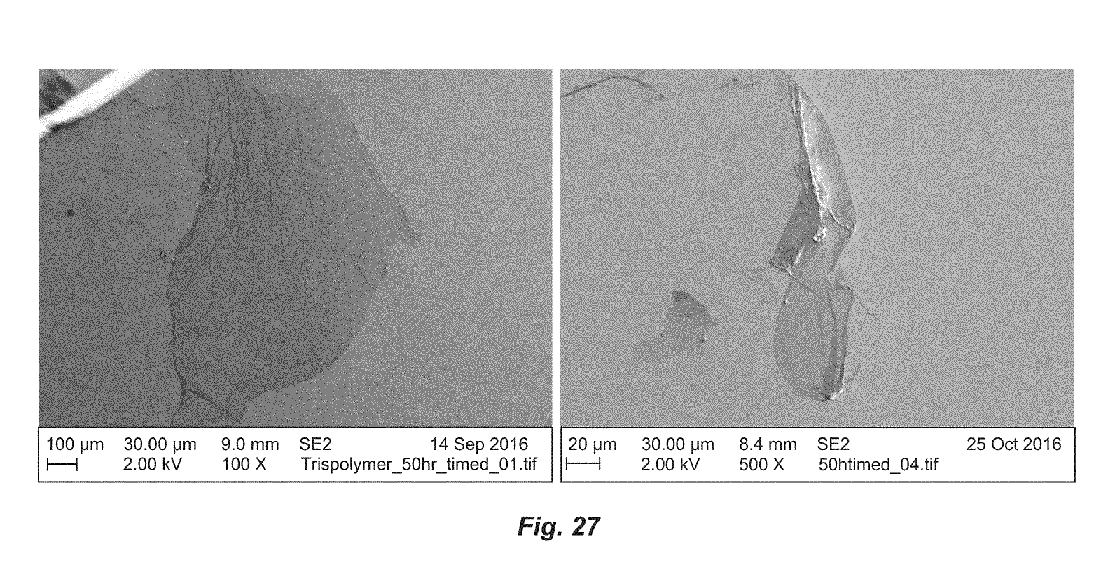

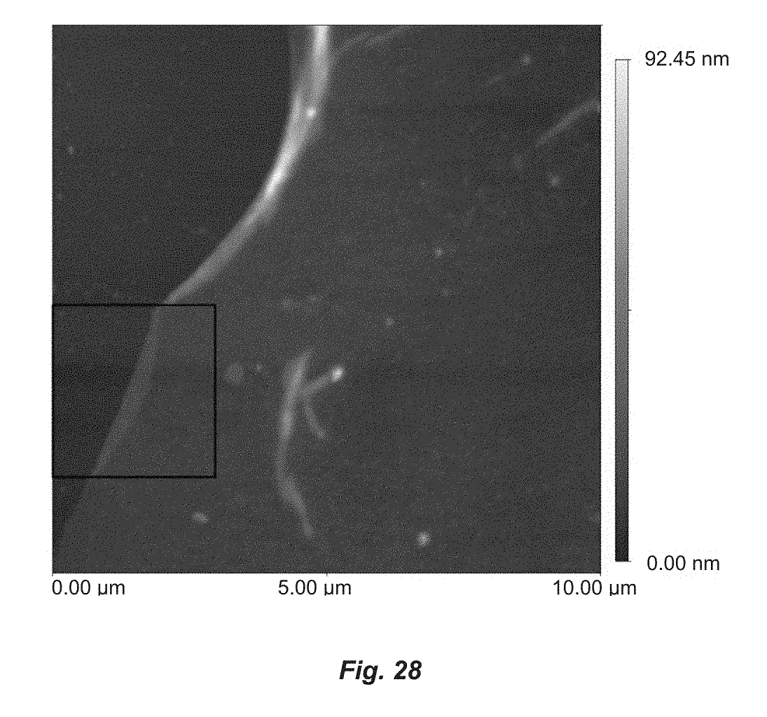

As shown in the right portion of FIG. 2, the permeability test also shows that the PFA-COF-1 thin film is, in fact, quite mechanically strong. TGA/DSC result (FIG. 11) shows that the PFA-COF-1 is stable over 300° C., indicating excellent thermal stability. The chemical stability of the PFA-COF-1 thin film was studied through a serious of chemical exposure tests followed by SEM analysis, comparing SEM images for the same sample and area before and after 30 min chemical treatment. Our initial results showed that the PFA-COF-1 thin films are reasonably stable in 98% H₂SO₄ and 70% HClO₄ (FIG. 24 and FIG. 25). However, the film was degraded by super strong oxidizing reagent piranha solution and strong base (1 M NaOH) due to oxidation and hydrolysis, respectively (FIG. 26 and FIG. 27).

In summary, we have successfully demonstrated the preparation of large area free standing ultra-thin 2D perfluoroalkylated COF film, PFA-COF-1, which can be captured on a substrate of interest when needed. The thickness of the film can be further fine-tuned by adjusting the reaction time. In addition to its fluorophilicity from compound M-1 which helps it dissolve in fluorocarbon solvents to achieve the liquid-liquid interfacial reaction with corresponding amines in hydrocarbon solvents, the highly electron-withdrawing nature of the perfluoroalklyl groups provide excellent thermal and chemical stabilities of the free standing 2D COF thin film. Such stabilities are particularly important toward many applications under extreme environmental conditions. Furthermore, as more fluorocarbon-soluble and hydrocarbon-insoluble precursors become available, this liquid-liquid interfacial synthetic strategy is expected to gain broad spectrum in large area thin film preparations particularly where other thin film preparation methods do not work. With this simple yet very effective synthetic method a large group of 2D functional organic materials is expected to be available for applications ranging from flexible organic electronics to separation and sensing technologies. Synthesis and integration of fluorocarbon-soluble air-stable organic semiconductor units into 2D COF thin films are currently underway in this lab.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### Examples

### Example 1. Synthesis and Characterizations (Scheme 2)

General Information:

All compounds and solvents used were purchased from commercial sources and used without further purification except where otherwise indicated. NMR data were recorded on a Bruker 400 MHz NMR spectrometer. MS spectra were recorded a GC-2010 plus Shimadzu mass spectrometer. FT-IR data was collected on a Nicolet 8700 FT-IR using a polished NaCl crystal where the COF thin film was captured from the fluorocarbon hydrocarbon interface. Photographs and videos were taken with a Canon EOS 7D camera with a Canon MP-E 65 mm f/2.8 1-5×Macro Photo Lens mounted on an adjustable optical rail system or a smart phone camera. Scanning electron microscope (SEM) images of PFA-COF-1 films were obtained using a Sigma HV FE-SEM from Carl Zeiss Microscopy LLC using polished silicon wafers (100 surface) as substrate. During SEM imaging experiments, 2 kV accelerating voltage and secondary electron detector with working distance around 8.5 mm were used. These SEM samples were then used for atomic force microscope (AFM) imaging (Pacific Nanotechnology Inc. Santa Clara, Calif.) to study mainly the thickness of the film. Experiments were conducted under ambient conditions and the tapping mode was used to obtain surface topography of PFA-COF-1 film. Chemical stability test of the PFA-COF-1 thin film on Si wafers were done by immersing in 1) 98% H₂SO₄ solution, 2) 70% HClO₄ solution, 3) piranha solution, and 4) 1 M NaOH solution for 30 mins each followed by DI water rinsing and drying. These samples were then examined by SEM again, then comparing the SEM images of the same samples before treatment. UV-Vis spectroscopy of the PFA-COF-1 films was done by using a Cary 5000 UV-visible-NIR spectrometer with PFA-COF-1 thin film sample onto a quartz slide. TGA-DSC analyses were conducted using a SDT Q600 V20.9 Build 20 instrument.

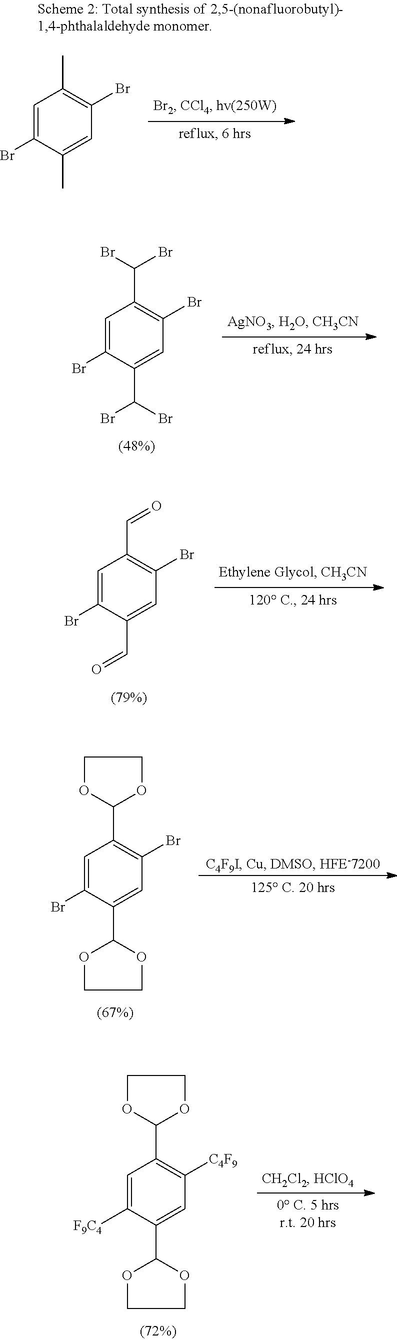

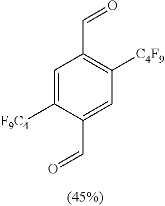

### Synthesis of 1,4-Dibromo-2,5-bis(dibromomethyl)benzene (1)

Compound 1 was synthesized using the reported procedure with slight modifications (Yang, X.; Liu, D.; Miao, Q. Angew. Chem., Int. Ed. 2014, 53, 6786). Five grams (19 mmol) of 1,4-dibromo-2,5-dimethylbenzene, 4.10 mL (79.8 mmol) of bromine, and 77 mL of CCl₄ were added into a 250 mL round bottom flask. The flask was heated to reflux and irradiated with a 250 W lamp for 6 hours. Then the solution was allowed to cool down to room temperature. Once cooled down, compound 1 precipitated out of solution to give a pure white solid. If the reaction was in small scale, the precipitate was collected with vacuum filtration followed by washes with small amount of n-hexane to remove excess bromine. If the reaction was in large scale, simple distillation was used to remove excess bromine, and then followed by cooling down, vacuum filtration, and n-hexane washes. Yield: 10.45 g (48%), ¹H NMR (400 MHz, CDCl₃) δ 6.93 (s, 2H), δ 8.15 (s, 2H). The NMR spectrum is consistent with reported data.

### Synthesis of 2,5-Dibromo-1,4-dicarbaldehyde (2)

Compound 2 was synthesized using the reported procedure with slight modifications (Yang, X.; Liu, D.; Miao, Q. Angew. Chem., Int. Ed. 2014, 53, 6786). A suspension of 8.0 g (14 mmol) of 1,4-dibromo-2,5-bis(dibromomethyl)benzene in 280 mL of acetonitrile was prepared. To this suspension, a solution of 16.65 g (98 mmol) AgNO₃ in 41 mL of DI H₂O was added. The flask was then covered with aluminum foil and heated to reflux for 24 hours instead of the 5 hours reported in the literature. Once finished, the solution was carefully filtered using gravity filtration. The pure product was quickly crystallized in solution when reaction time is extended, allowing immediate vacuum filtration and washing with cold acetonitrile to afford a pure white product. Yield: 3.2 g (79%). ¹H NMR (400 MHz, CDCl₃) δ 8.18 (s, 2H), δ 10.37 (s, 2H).

### Synthesis of 2,2′-(2,5-dibromobenzene-1,4diyl)bis(1,3-dioxolane) (3)

3.075 g (11 mmol) of compound 2 was added into a solution of 0.332 g (1.43 mmol) of camphorsulfonic acid, 116 mL (2080 mmol) ethylene glycol, and 147 mL of acetonitrile. The solution was heated to 120° C. using an oil bath for 24 hours, then the solution was cooled down to room temperature, then placed into a freezer for 3 hours. After cooling in the freezer, a flaky, white precipitate collected at the bottom of the flask. This was collected by vacuum filtration and washed with cold acetonitrile. Subsequent removal of excess solvent followed by cooled down in a freezer produced more precipitate. Yield: 2.66 g (67%). ¹H NMR (400 MHz, CDCl₃) δ 4.09-4.21 (m, 8H), δ 6.05 (s, 2H), δ 7.79 (s, 2H).

### Synthesis of 2,2′-(2,5-nonofluorobutylbenzene-1,4diyl)bis(1,3-dioxolane) (4)

1.0 g (2.6 mmol) of compound 3 was added into a pressure tube with a magnetic stir bar. Then 1.70 g (27 mmol) Cu powder, 2.19 mL (12.7 mmol) of nonafluorobutyl iodide, 8.4 mL DMSO, and 8.4 mL of HFE-7200 were added and the tube was sealed tight. The tube was then placed into an oil bath and heated to 120° C. for 20 hours. Once finished, the pressure tube was cooled down to room temperature and slowly opened to release pressure. Two 50 mL portions of CH₂Cl₂ were added into the tube, sonicated for 15 minutes each, and vacuum filtered. The filtrate was then washed with DI H₂O, dried with MgSO₄, and the solvent removed by rotovap. The product yield was 1.243 g (72% yield). ¹H NMR (400 MHz, CDCl₃) δ 4.09-4.21 (m, 8H), 6.07 (s, 2H), 8.07 (s, 2H).

### Synthesis of 2,5-bis(nonafluorobutyl)-1,4-phthalaldehyde (M-1)

3.32 g (5 mmol) of compound 4 was added into 200 mL of CH₂Cl₂ and cooled in an ice bath. Then 12 mL of 70% HClO₄ was added slowly, dropwise into the solution with stirring. The solution was kept at 0° C. for 5 hours, then was allowed to slowly warm up to room temperature and continue for 20 hours. Once finished, the solution was carefully poured into a beaker containing 300 mL of DI H₂O. The methylene chloride layer was collected, and then washed three times with 50 mL DI H₂O and once with 40 mL brine solution. The collected organic layer was then dried with MgSO₄, filtered, and the solvent was removed to yield 1.5 g (45%) of 5. ¹H NMR (400 MHz, CDCl₃) δ 8.49 (s, 2H), δ 10.40 (s, 2H). m.p. 128-131° C.; m/z 569 (M⁺).

### Synthesis of perfluoroalkylated imine-linked covalent organic framework (PFA-COF-1)

The synthesis of the PFA-COF-1 was accomplished using two stock solutions containing the 2,5-bis(nonafluorobutyl)-1,4-phthalaldehyde (M-1) and 1,3,5-Tris(4-aminophenyl)benzene (N-1) building blocks. 14.1 mg of N-1 was dissolved in 20 mL of DMSO (a faint yellow solution due to the oxidation impurity). Next, 68.4 mg of M-1 was dissolved in 60 mL of HFE-7200 to generate a large stock solution for multiple runs with N-1. 1 mL of M-1/HFE-7200 solution was added into a 3 mL vial. Then, N-1/DMSO layer was carefully added to develop the second layer, but at a rate to prevent any excessive force that would cause DMSO to have extraneous mixing with the bottom layer. For placing the PFA-COF-1 onto difference substrates, silicon wafer (100 surface), quartz slide, or glass slide would be placed into the HFE-7200 layer before the addition of the DMSO. Note: for a small ø12 mm 3 mL vial, minimum of 1 ml HFE-7200/M-1 solution and 0.5 ml DMSO/N-1 solution are needed to develop a clear liquid-liquid interface. Further, strong vibration and light should be avoided in order to growth smooth ultra-thin PFA-COF-1 film.

### Example 2. Optimization of PAF-COF-1 Thin Film Formation Condition

Optimization of the PAF-COF-1 thin film formation time at the liquid-liquid interface was accomplished using a set of eight silicon wafer substrates partially submerged into the solvents. In the period of 2 to 50 hours from the reaction start, the substrate was removed from the vial periodically, washed gently with CH₂Cl₂ dropwise from a syringe, and then placed into an oven set to 70° C. Then SEM images of these samples were used to judge if the film was completely formed.

The total amount of solution being used to wash the PFA-COF-1 film on the substrates began to increase as solvent beaded up on the PFA-COF-1 film and easily slipped off the sides. To ensure the removal of excess monomers on the film surface, the total amount of solvent used for washes was increased. Solvent bead up on the substrate surface was observed for the PFA-COF-1 films formed at 48 hours or longer. The SEM images these PFA-COF-1 film clearly showed the growth of the PFA-COF-1 film over time. Based on this experimental evidence, we conclude that 48 hours reaction time (at room temperature) to be optimal for the films to develop across the entire liquid-liquid interface area.

Photographic Evidence of Ultra-Thin Films.

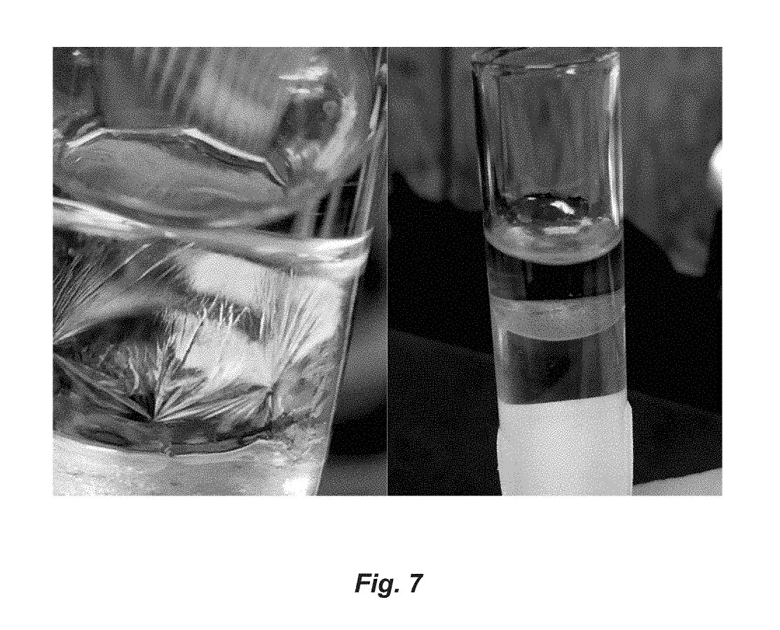

Photographs in FIG. 7 were taken 72 hours after the reaction started. The pictures shown below with clear evidence of film formation, light reflection, and wrinkle formation upon perturbation to the solvent-solvent interface.

### Example 3. Permeability Test with HFE-7200 Blue Fluorescent Dye Solution

In order to test the permeability of the PFA-COF-1 film after fully developing, a solution of 1,4,6,9-tetrakis(heptadecafluorooctyyl)anthracene, a blue fluorescent dye, in HFE-7200 was added dropwise (˜15 μL) using a microliter syringe onto the PFA-COF-1 film through the DMSO layer. The control experiment showed that HFE-7200/dye droplets immediately went into the HFE-7200 layer. The polymer demonstrated noteworthy strength after addition of the HFE-7200/dye solution without breaking or allowing immediate diffusion. However, the polymer was not anchored to the wall of the vial and, as a result, once the HFE-7200/dye droplet grew large enough on the edge of the film, it finally slipped through the interface. A series of photographs captured from a video clip of this simple yet effective experiment are shown below (FIG. 8). The permeability of the PFA-COF-1 film was further investigated over the period of a couple months. We observed no noticeable changes in the size of the solvent droplets (FIG. 9).

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A fluoropolymer film comprising:
a) a repeat unit A, wherein a monomer 1A that forms repeat unit A is soluble in a polar organic solvent and is substantially insoluble in a fluorocarbon solvent; and
b) a repeat unit B, wherein a monomer 2B that forms repeat unit B is soluble in the fluorocarbon solvent and is substantially insoluble in the polar organic solvent, and wherein repeat unit B and monomer 2B are substituted with a perfluorocarbon substituent;
wherein a combined repeating unit of the fluoropolymer film comprises repeat unit A and repeat unit B covalently bonded together, and the fluoropolymer film has a thickness of about 0.1 nm to about 10,000 nm and an area to thickness aspect ratio of about 10³ to about 10¹⁴.

2. The fluoropolymer film of claim 1 wherein the perfluorocarbon substituent is a perfluoroalkyl substituent.

3. The fluoropolymer film of claim 2 wherein the perfluoroalkyl substituent is Formula I:
—(CH₂)ₘ—(CF₂)ₙ—CF₃ (I);
wherein
m is 0-30; and
n is 0-30.

4. The fluoropolymer film of claim 1 wherein monomer 1A is aromatic monomer 1A having one or more substituents, and monomer 2B is aromatic monomer 2B having two or more substituents, wherein aromatic monomer 1A and aromatic monomer 2B form the combined repeating unit of the fluoropolymer film.

5. The fluoropolymer film of claim 4 wherein aromatic monomer 1A, or aromatic monomer 2B, is a phenyl, pyrene, naphthalene, anthracene, coronene, furan, pyridine, pyrazine, pyrimidine, indole, imidazole, oxazole, phenanthroline, phthalocyanine, porphyrin, metallophthalocyanine, or metalloporphyrine.

6. The fluoropolymer film of claim 4 wherein each substituent on aromatic monomer 1A or aromatic monomer 2B is independently halo, alkyl, amino, imine, hydroxyl, carbaldehyde, carboxyl, sulfonyl, phosphoryl, phenyl, aryl, heteroaryl, or a combination thereof, and wherein phenyl, aryl or heteroaryl are optionally substituted with one or more said substituents.

7. The fluoropolymer film of claim 6 wherein the substituent is halo, amino, carbaldehyde, or phenyl.

8. The fluoropolymer film of claim 1 wherein monomer 1A that forms repeat unit A is Formula II: 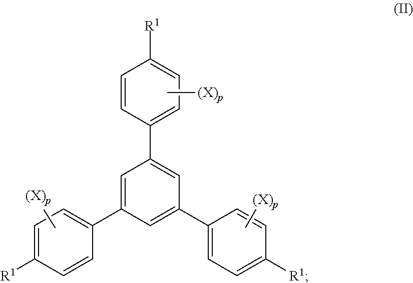
wherein
R¹ is OH or NH₂;
each X is independently F, Cl, Br, CH₃, CH₂CH₃, OH, NH₂, or C(O)OH; and
each p is independently 0-4.

9. The fluoropolymer film of claim 1 wherein the monomer 2B that forms repeat unit B is Formula III: 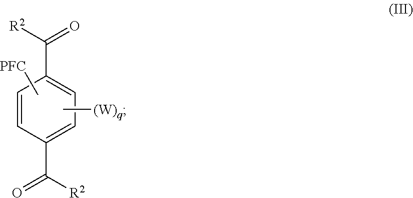
wherein
R² is H, OH, alkyl, or aryl;
PFC is a perfluorocarbon;
each W is independently F, Cl, Br, CH₃, CHF₂, CF₃, CH₂CH₃, or PFC; and
q is 0-3.

10. The fluoropolymer film of claim 1 wherein the combined repeating unit comprises Formula IV: 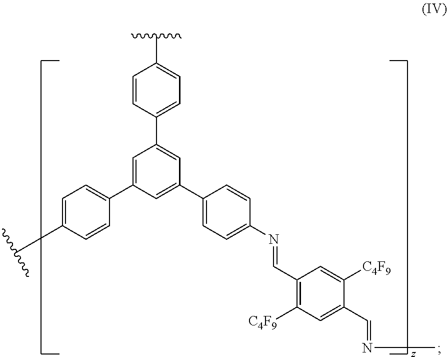
wherein
z is >1; and
z is bonded to an additional z through a C—N bond.

11. The fluoropolymer film of claim 1 wherein the fluoropolymer film has a thickness of about 0.1 nm to about 1,000 nm and an area to thickness aspect ratio of about 10⁴ to about 10¹⁰.

12. The fluoropolymer film of claim 11 wherein the fluoropolymer film is in the form of a fluoropolymer monolayer.

13. The fluoropolymer film of claim 11 wherein the fluoropolymer film is porous.

14. A fluoropolymer monolayer comprising:
a) an aromatic repeat unit A, wherein an amino substituted monomer 1A that forms repeat unit A is soluble in a polar organic solvent and is substantially insoluble in a fluorocarbon solvent; and
b) an aromatic repeat unit B, wherein a carbaldehyde substituted monomer 2B that forms repeat unit B is soluble in the fluorocarbon solvent and is substantially insoluble in the polar organic solvent, and wherein repeat unit B and monomer 2B are substituted with a perfluorocarbon substituent;
wherein a combined repeating unit of the fluoropolymer monolayer comprises repeat unit A and repeat unit B covalently bonded together via an imine linkage, and the fluoropolymer monolayer has a thickness of about 0.1 nm to about 100 nm, and an area to thickness aspect ratio of about 10⁴ to about 10¹⁰.

15. A method of preparing the fluoropolymer film of claim 1, comprising:
a) dissolving monomer 1A in a polar organic solvent to form solution 1;
b) dissolving monomer 2B in a fluorocarbon solvent to form solution 2; and
c) combining solution 1 and solution 2 to form a bilayer interface wherein solution 1 and solution 2 are substantially immiscible with each other, thereby forming a fluoropolymer film at the bilayer interface.

16. A method of preparing a fluoropolymer film, comprising:
a) dissolving an aromatic monomer 1A in a polar organic solvent to form solution 1;
b) dissolving an aromatic monomer 2B in a fluorocarbon solvent to form solution 2, wherein monomer 2B has at least one perfluorocarbon substituent; and
c) combining solution 1 and solution 2 to form a bilayer interface wherein solution 1 and solution 2 are substantially immiscible with each other, wherein monomer 1A is substantially insoluble in solution 2, and monomer 2B is substantially insoluble in solution 1, thereby forming a fluoropolymer film at the bilayer interface;
wherein the repeating unit of the fluoropolymer film is formed from monomer 1A and monomer 2B covalently bonded together, and the fluoropolymer film has a thickness of about 0.1 nm to about 1000 nm and an area to thickness aspect ratio of about 10⁴ to about 10¹⁴.

17. The method of claim 16 wherein the polar organic solvent is dimethyl sulfoxide (DMSO), dimethyl formamide (DMF), N-methyl-2-pyrolidinone (NMP), or acetonitrile (ACN).

18. The method of claim 16 wherein the fluorocarbon solvent is a hydrofluoroether, perfluoropolyether, perfluorocarbon, or a combination thereof.

19. The method of claim 16 wherein the perfluorocarbon substituent is —C₄F₉, —C₆F₁₃, —C₈F₁₇, or —C₁₂F₂₅.

20. The method of claim 16 wherein the fluoropolymer film is a porous monolayer.
